(19) United States
(12) Patent Application Publication
(10) Pub. No.: US 2010/0102562 A1
(43) Pub. Date: Apr. 29, 2010

(54) WAVE ENERGY RECOVERY SYSTEM

(76) Inventors: Alexander Greenspan, Solon, OH (US); Gregory Greenspan, Solon, OH (US); Gene Alter, Chagrin Falls, OH (US)

Correspondence Address: MCDONALD HOPKINS LLC, 600 Superior Avenue, East, Suite 2100, CLEVELAND, OH, 44114-2653, US

(21) Appl. No.: 12/466,960

(22) Filed: May 15, 2009

Related U.S. Application Data
(60) Provisional application No. 61/127,699, filed on May 15, 2008.

(51) Int. Cl. F03B 13/16

(52) U.S. Cl. 290/53

(57) ABSTRACT

The present invention includes novel apparatus and methods for recovering energy from water waves. An embodiment of the present invention may include a buoy, a shaft, and an electric power generating device. The shaft may be coupled to the buoy such that when the buoy moves vertically in response to a passing wave, the shaft rotates. The shaft may be coupled to the electric power generating device such that when the shaft rotates, the generating device produces electric power. Once electric power is generated, it may be delivered to shore, where it is stored, used to power a device, or delivered to a power distribution grid.

### CROSS-REFERENCE TO RELATED APPLICATION

This application claims benefit from U.S. Provisional Patent Application No. 61/127,699, entitled “Wave Energy Recovery System,” filed on May 15, 2008, which is hereby incorporated in its entirety by reference.

### FIELD OF INVENTION

The present invention relates generally to systems for recovering energy from waves and, more particularly, the present invention relates to an apparatus and methods for transforming vertical displacement of buoys caused by waves into rotational motion that is converted into energy, such as electric power.

### BACKGROUND

Currently, approximately 350 million megawatt-hours of energy are consumed globally each day (which is equivalent to the energy in approximately 205 million barrels of oil). With continued industrial expansion and population growth throughout the developed and developing world, global consumption is expected to increase approximately sixty percent over the next twenty-five years, pushing global energy consumption to over 500 million megawatt-hours per day.

Approximately seventy-five percent of energy currently consumed comes from non-renewable sources, such as oil, coal, natural gas, and other such fossil fuels. The current level of fossil fuel usage accounts for the release of approximately six million tons of carbon dioxide into the atmosphere each day. With a finite supply of fossil fuels available and growing concerns over the impact of carbon dioxide, continued reliance on fossil fuels as a primary source of energy is not indefinitely sustainable.

One approach to sustaining the current global energy consumption rate and accounting for future increases in consumption is to research and develop novel and improved methods for generating energy from renewable sources. Sources of renewable energy include water-powered energy, wind-powered energy, solar energy, and geothermal energy. Of the current practical renewable energy sources, water-powered energy, and specifically wave-powered energy, may hold the most promise for developing a substantial renewable energy source to meet growing global energy needs.

It has been long understood that ocean waves contain considerable amounts of energy. Given the high level of energy concentration present in waves and the vast areas available for harvesting such energy, wave-powered energy technology represents a significant renewable energy source. Numerous systems have been developed in an attempt to efficiently capture the energy of waves; however, no prior conceived systems or methods have achieved the efficiency or cost-effectiveness required to make wave-powered energy a viable alternative energy source.

Wave energy recovery systems must successfully operate in very hostile marine or freshwater environments. Such environments are prone to violent storms and the

deleterious impact of salt water, plant life, and animal life. Further, due to the offshore location of such systems, a successful system must include an efficient means for delivering the energy output to shore. These and other technical challenges have been addressed and overcome by this invention as herein described.

### SUMMARY OF INVENTION

The present invention includes novel apparatus and methods for recovering energy from water waves. An embodiment of the present invention includes a buoy, a shaft, and an electric power generating device. The shaft may be coupled to the buoy such that when the buoy moves vertically in response to a passing wave, the shaft rotates. The shaft may be coupled to the electric power generating device such that when the shaft rotates, the electric power generating device produces electric power. Once electric power is generated, it may be delivered to shore, where it is stored, used to power a device, or delivered to a power distribution grid.

### DESCRIPTION OF DRAWINGS

Objects and advantages together with the operation of the invention may be better understood by reference to the following detailed description taken in connection with the following illustrations, wherein:

FIG. 1 illustrates a view of an embodiment of a wave energy recovery system.

FIG. 2 is a schematic view of an embodiment of a wave energy recovery system.

FIG. 3 is a schematic illustration of another embodiment of a wave energy recovery system.

FIG. 4 is a side cross-sectional view of a platform, generator, and drum mechanism of the wave energy recovery system of FIG. 1.

FIG. 5 is a side cross-sectional view of the drum mechanism and generator of FIG. 4.

FIG. 6 is a side view of the drum mechanism of the wave energy recovery system of FIG. 1.

FIG. 7 is a magnified view of the drum mechanism of FIG. 4.

FIG. 8 is a magnified view of a clutch of the drum mechanism of FIG. 7.

FIG. 9 is a top view of the drum mechanism and guide plates.

FIG. 10 is a top view of the guide plates of FIG. 9.

FIG. 11 is a side view of the generator.

FIG. 12 is a rear view of the generator and platform of the wave energy recovery system of FIG. 4.

FIG. 13 is a front view of an oil pump of the wave energy recovery system of FIG. 4.

FIG. 14 is a perspective view of a buoy.

FIG. 15 is a side view of a buoy in accordance with the present invention.

FIG. 16 is a top view of a buoy.

FIG. 17 is another side view of the buoy of FIG. 16.

FIG. 18 is a side view of the buoy of FIG. 14.

FIG. 19 is a close up side view of the buoy of FIG. 18 without paddles.

FIGS. 20A and 20B are views of a retracting buoy.

FIG. 21A is a close up perspective view of a paddle mechanism of FIG. 14.

FIG. 21B is a close up side view of an alternative paddle mechanism.

FIG. 22 is a schematic view of a valve and cylinder system.

FIG. 23 is a side cross sectional view of a valve.

FIG. 24 is a side cross sectional view of a return tank for the valve of FIG. 23.

FIG. 25 is a perspective view of a valve of FIG. 23.

FIG. 26 is a perspective view of the return tank of FIG. 24.

FIG. 27 illustrates a schematic illustration of an alternative embodiment of a wave energy recovery system.

FIGS. 28 and 29 illustrate detailed views of the wave energy recovery system of FIG. 27.

FIG. 30 illustrates a view of an alternative embodiment of a wave energy recovery system.

FIG. 31 illustrates a manifold for use with a buoy of the wave energy recovery system.

FIG. 32 illustrates a check valve of a pedal compression mechanism for use with a buoy of the wave energy recovery system.

FIG. 33 illustrates a view of an alternative embodiment of a pneumatic system for the wave energy recovery system.

### DETAILED DESCRIPTION

While the present invention is disclosed with reference to the embodiments described herein, it should be clear that the present invention should not be limited to such embodiments. Therefore, the description of the embodiments herein is only illustrative of the present invention and should not limit the scope of the invention as claimed.

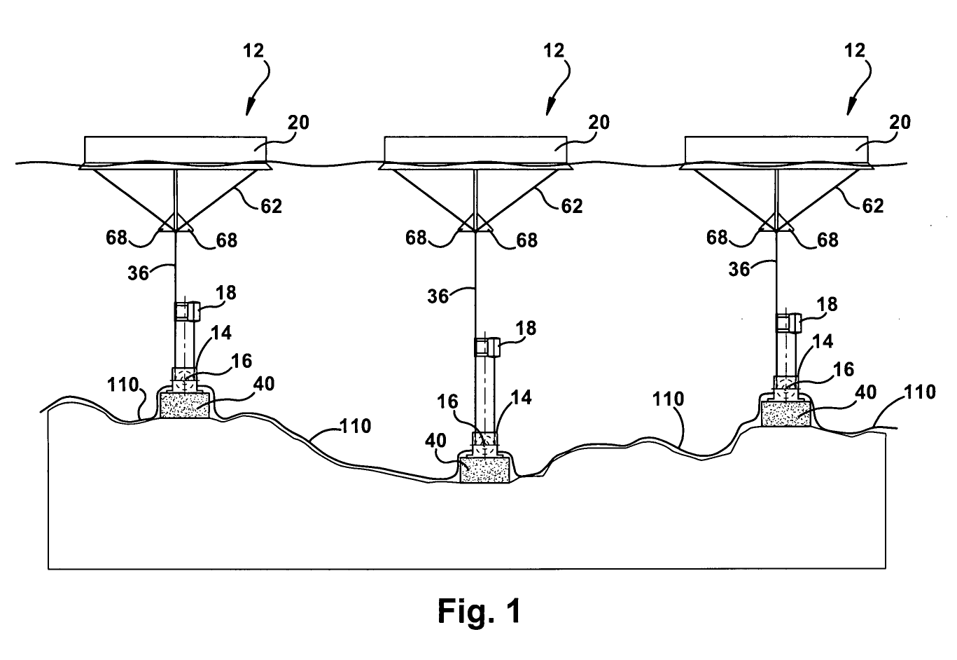

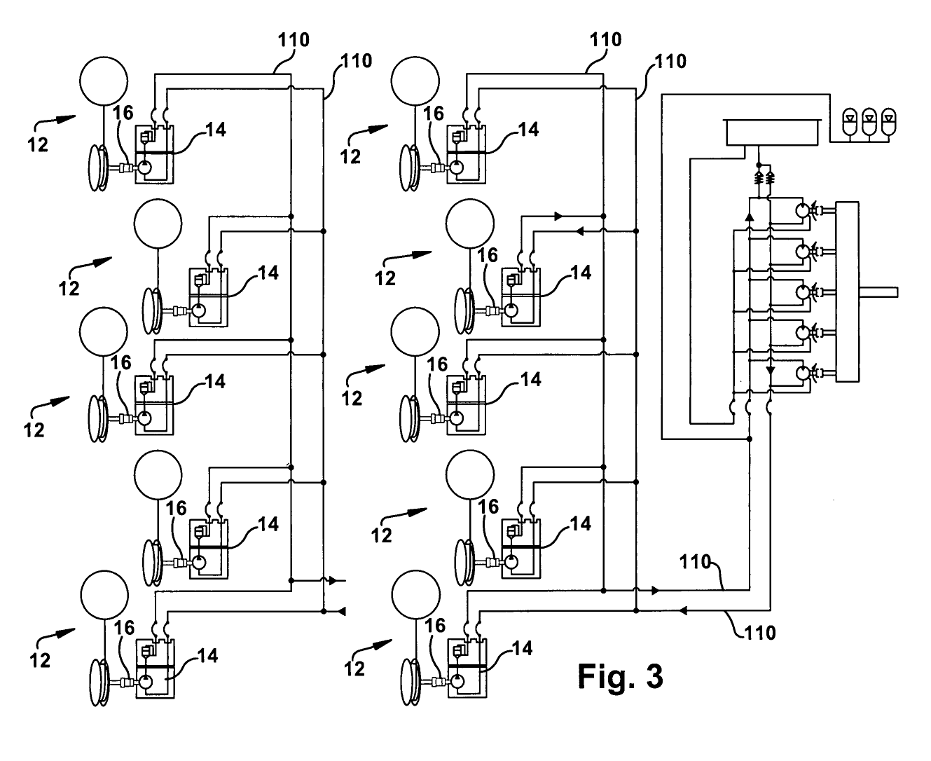

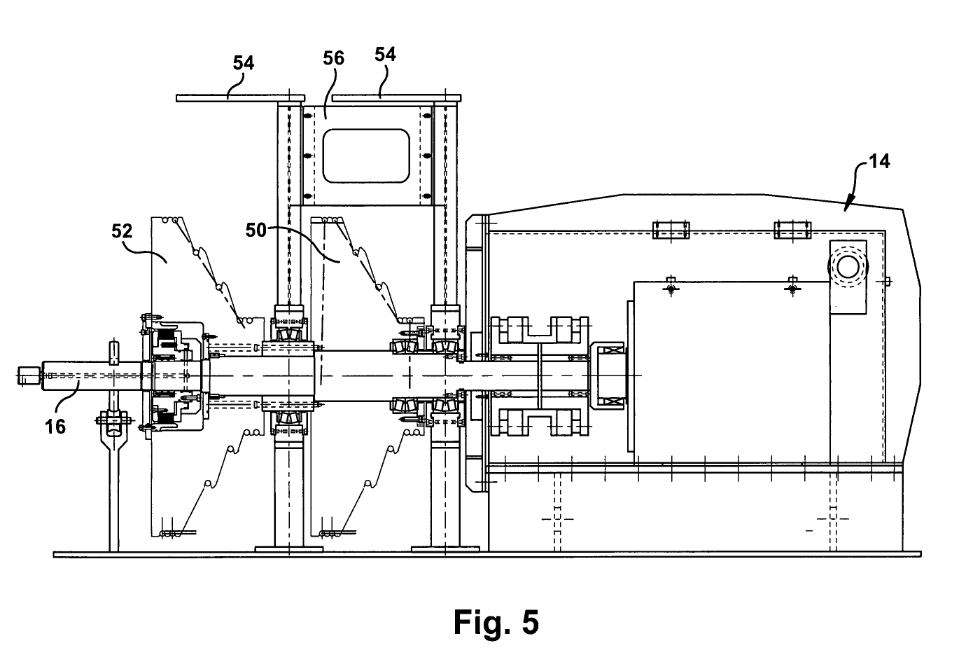

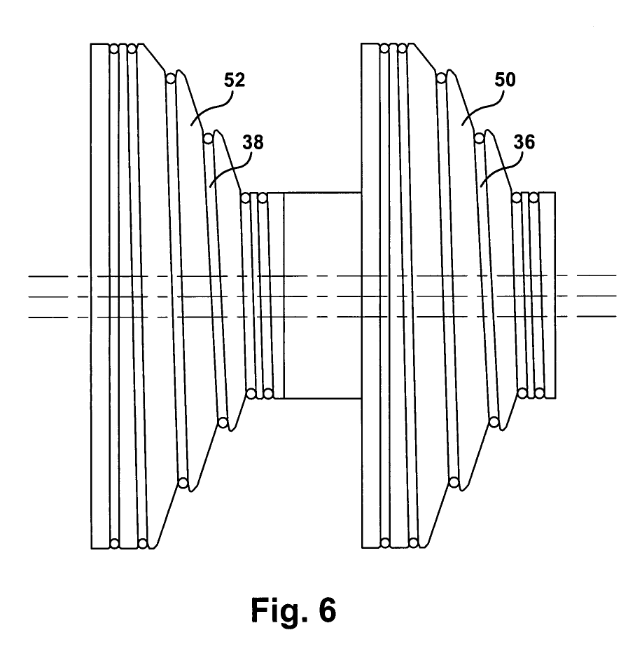

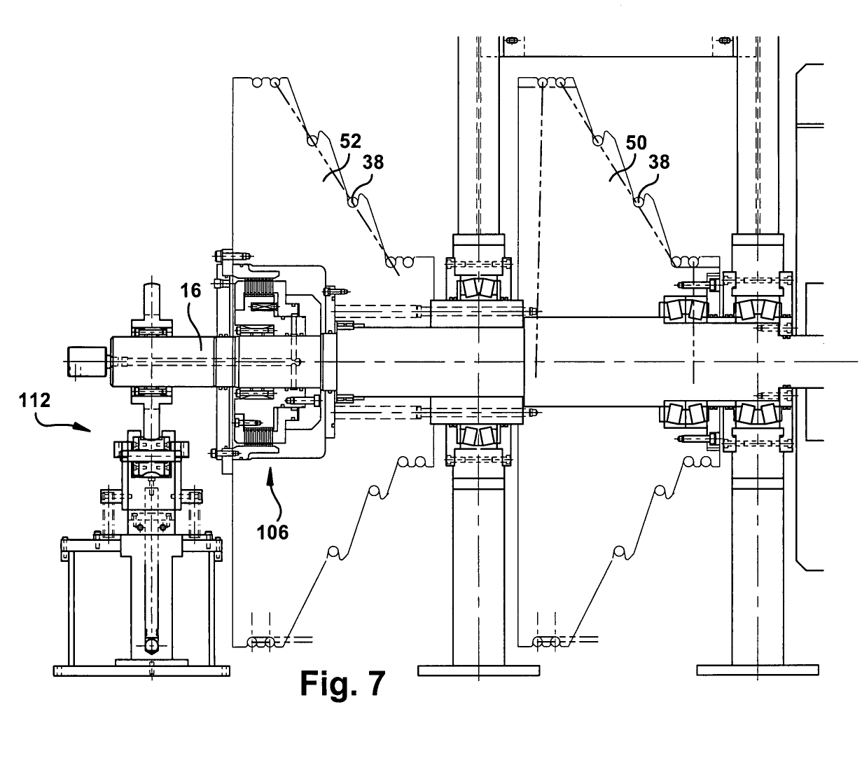

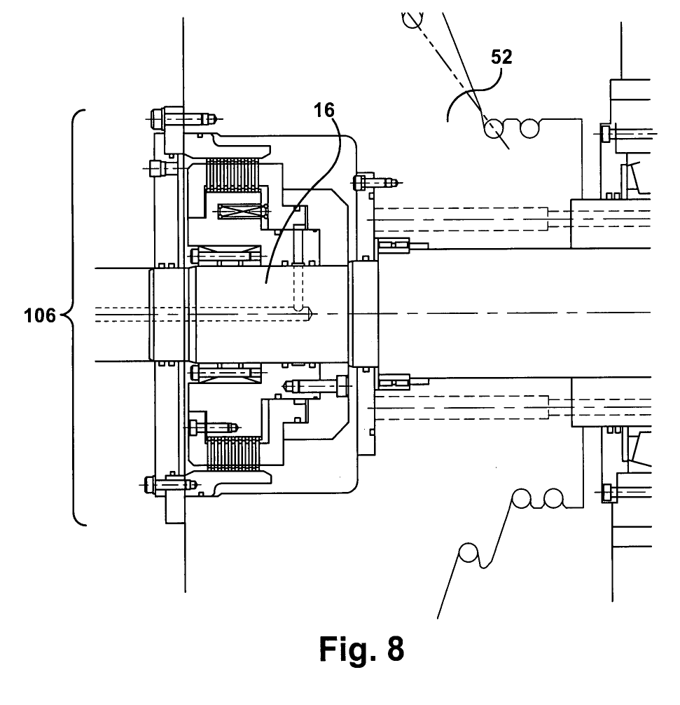

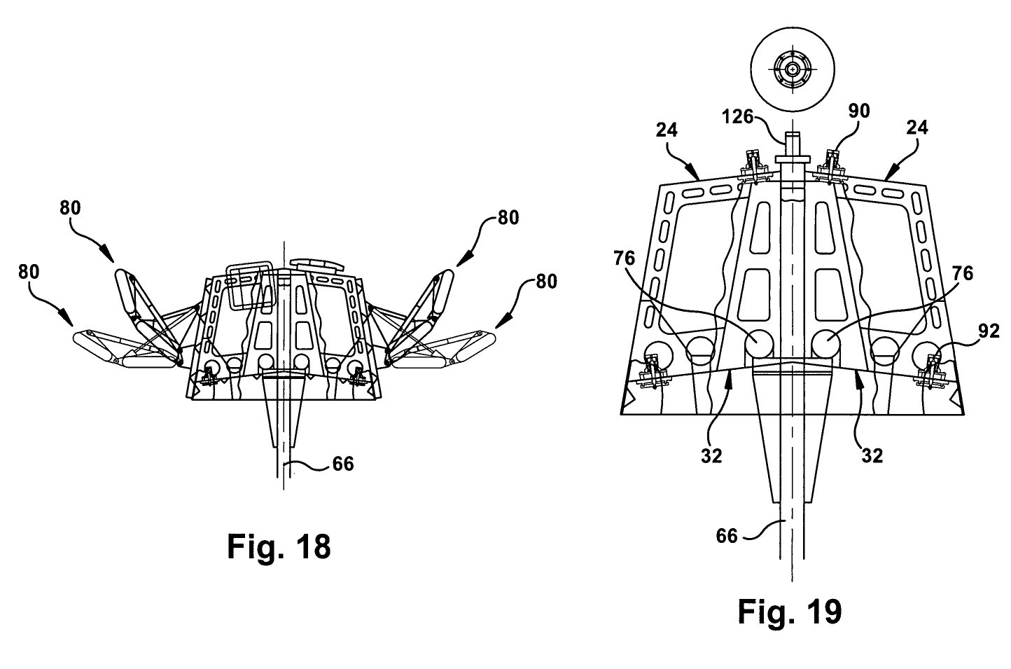

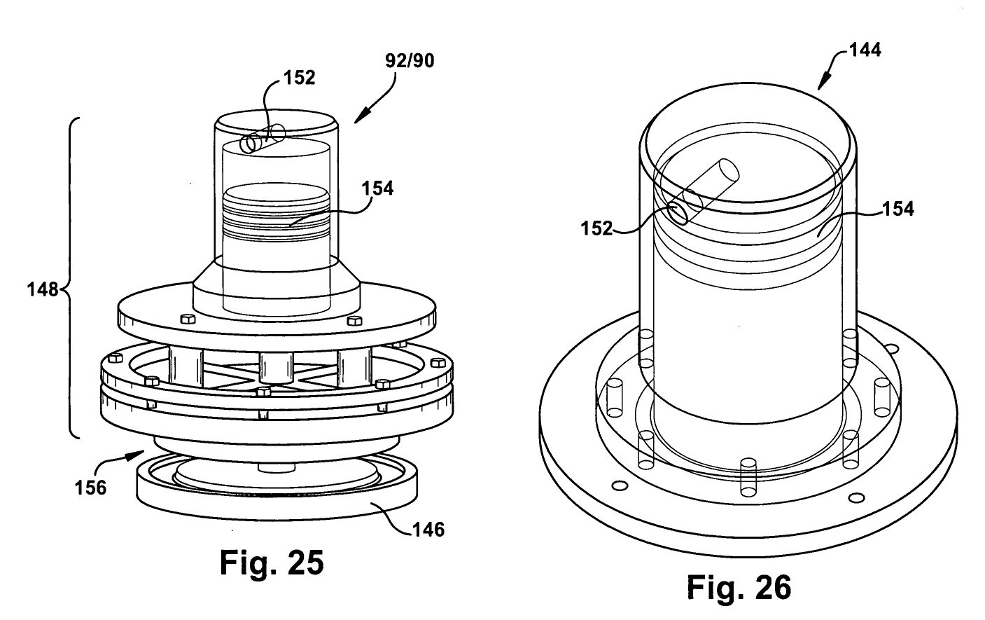

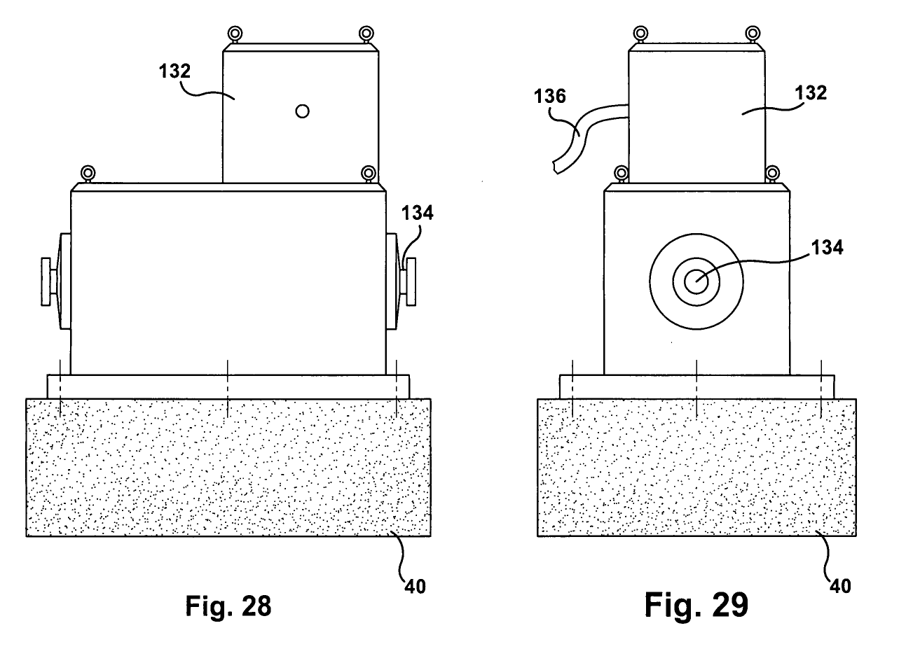

A wave energy recovery system, as described herein and illustrated in FIGS. 1-33, converts the energy of sea or ocean waves or other such water waves into usable mechanical and electrical energy. Apparatus and methods may be arranged such that the vertical pulse motion of waves of any magnitude and frequency may be converted to other types of motion such as, for example, linear or rotational motion. The mechanical energy of this resulting motion may be arranged to drive gearboxes, motors, pumps, various types of generators, or the like so as to generate energy, such as electrical power.

In an embodiment, the vertical pulse motion of a wave may be translated to a buoy 20 floating at or near the surface of a body of water to vertically displace the buoy 20. The vertical displacement of the buoy 20 may be translated to linear motion of a cable that is coupled to the buoy 20. The cable may be wrapped around a pulley or drum 50, and the linear motion of the cable may be translated to rotational motion of the pulley or drum 50 to drive a generator 14, thereby capable of generating electric power. The generator 14 may be of any appropriate type, such as an alternating current (AC) permanent magnet generator. In addition, a plurality of motion translating assemblies 12 may be arranged in series or parallel. The system 10 is capable of operating without a gearbox, as there is no switching of gears, with the drums 50, 52 and use of a gearbox may decrease the efficiency of the generator 14.

The AC permanent magnet generator 14 may be coupled to a rectifier to convert the alternating current (AC) produced by the generator 14 to a direct current (DC). The rectifier may be coupled to a voltage converter to generate a consistent DC current that may be used as a final source of electricity or to be converted back to AC current and delivered to a power generation grid. As used herein, the term “coupled” means directly or indirectly connected in a mechanical, electrical, or other such manner.

FIG. 1 illustrates a wave energy recovery system 10. The system 10 may comprise a motion translating assembly 12, a generator 14, a shaft 16, and a platform 40. The system 10 may be positioned at any appropriate location on the floor of the ocean or other body of water and may be positioned relatively close to shore. The system 10 may be arranged so as to generate electrical power and deliver that electrical power to shore. As will be further described below, the motion translating assembly 12 may translate the vertical pulse motion of a wave to rotational motion of the shaft 16, and such rotational motion of the shaft 16 may drive the generator 14.

In an exemplary embodiment illustrated in FIG. 1, each motion translating assembly 12 may be arranged to drive a shaft 16 attached to a generator 14 independently connected to and dedicated to that assembly 12. The vertical motion of the main buoy 20 may be translated to rotational motion to rotate a shaft 16 that is coupled to and drives the generator 14 so as to produce electrical power.

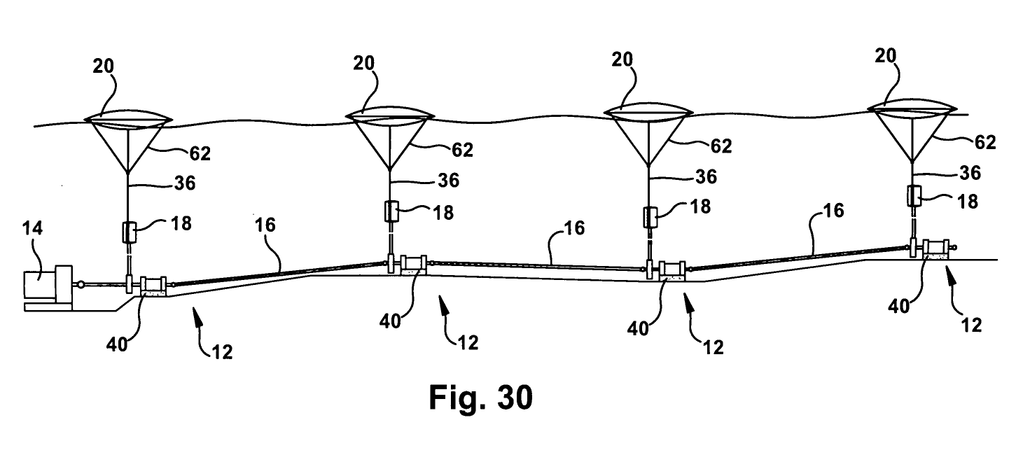

As an alternative, a plurality of motion translating assemblies 12 may be coupled to a shaft to drive the generator, which may be located adjacent to the motion translating assembly 12 that is closest to the shore, as illustrated in FIG. 30. In such an arrangement, it would be preferable that the shaft 16 only rotate in one direction. As multiple motion translating assemblies 12 assist in rotating the shaft 16, limiting the shaft 16 to only one direction of rotation may allow the assembles 12 to cooperate in driving the generator 14. The coupling of numerous motion translating assemblies 12 to one generator may provide for a continuous rotation of the shaft 16 and an efficient method of driving the generator 14.

The generated electrical power may be delivered to shore, either for immediate use or to feed into a power distribution grid. As an alternative, the system 10 may be arranged so as to generate electrical power and to utilize and store that electrical power locally on the system 10 to drive devices on the system 10 or near the system 10.

With further reference to FIG. 1, a motion translating assembly 12 may include a main buoy or float 20, a retracting buoy or float 18, and a main cable 36. The main cable 36 may be coupled on one end to the main buoy 20, coupled on the other end to the retracting buoy 18, and wrapped around the drum 52. As an alternative, each drum 50, 52 may have its own dedicated cable 36, 38. In addition, each dedicated cable 36, 38 may be coupled to its own dedicated buoy 18, 20. For example, the main cable 36 may be coupled to the main buoy 20 and the drum 50, and the other cable 38 may be coupled to the retracting buoy 18 and drum 52, so that when one drum 50 turns in a first direction, such as clockwise, for example, the other drum 52 may turn in the same or an opposite direction, such as counterclockwise, for example.

While the motion translating assembly 12 and the ability to rotate is discussed in terms of utilizing drums 50, 52, it is to be understood that any appropriate type of rotating mechanism or apparatus may be utilized, such as pulleys (not shown), for example. If pulleys are utilized, they may be located within a pulley housing (not shown). As an alternative embodiment, the main cable 36 may be coupled on one end to the main buoy 20, coupled on the other end to the retracting buoy 18, and wrapped around an oscillating pulley (not shown) that may be located within a pulley housing.

The buoys 18 and 20 may be arranged such that, as a wave engages the main buoy 20, the main buoy 20 may be displaced vertically upward (i.e., rises relative to the ocean floor) and the cable 36 rotates the drum 50 in a clockwise rotation. As the wave passes the main buoy 20, the main buoy 20 may be displaced vertically downward (i.e., falls relative to the ocean floor), the retracting buoy 18 rises to remove any slack from the cable 38, and the drum 52 rotates counterclockwise. Thus, as waves pass the main buoy 20, vertical displacement of the main buoy 20 due to passing waves is transformed into linear motion of the main cable 36 and rotational motion of the drums 50, 52.

Although the cables 36, 38, buoys 20, 18 and drums 50, 52 have been described as being coupled in various ways, it will be readily understood by those skilled in the art that any number of additional arrangements may be utilized to convert vertical motion of the main buoy 20 to rotational motion, and should not be limited to those arrangements described herein.

The drums 50, 52 may be coupled to the shaft 16 such that rotational motion of the drums 50, 52 translates to rotational motion of the shaft 16. The shaft 16 may be coupled to the generator 14 such that rotational motion of the shaft 16 translates to rotational motion of the generator 14. The generator 14 may utilize such rotational motion to generate energy, such as electrical power. As the generator 14 generates electrical power, the power may be delivered to the shore through a power cable 110 attached to the generator 14.

The drums 50, 52 may drive the shaft 16 that drives the generator 14 to create electrical power. The inner drum 50 may operate the main buoy 20. The outer drum 52 may operate the counter buoy 18. The drums 50, 52 may be of any appropriate shape or size, such as of a substantially conical shape, cylindrical shape, or the like. If of a conical shape, the drums 50, 52 may be wrapped with the cable or wire 36, 38 all the way up and around the incline of the cone shape. The conical shape may allow the drums 50, 52 to rotate via a linear graduation, thereby providing a linear power graduation. Thus, the drums 50, 52 may spin at low rpms and, for example, may be prevented from rotating more than sixty (60) turns. Linear graduation may be achieved by providing the same distance between each step or location where the wire 36 or 38 is placed or wrapped on the drum 50 or 52. However, as an alternative, the system 10 may utilize a non-linear graduation.

The system 10 also may utilize a standard hydraulic clutch 106. For example, when the drums 50, 52 spin at or near 60 RPMs, the clutch 106 may be activated to slow movement of the drums 50, 52. As is well known in the art, the clutch 106 may operate due to frictional engagement of a clutch plate and a flywheel. The flywheel may be a large steel or aluminum “disc,” that may be bolted to the driveshaft 16. The flywheel may act as a balancer for the generator 14, dampen vibrations, and provide a smooth-machined “friction” surface that the clutch 106 can contact. The main function of the flywheel is to transfer engine torque from the engine to the transmission.

The clutch disc may be similar to a steel plate and covered with a frictional material that is located between the flywheel and the pressure plate. In the center of the disc is the hub, which is designed to fit over the shaft 16. When the clutch 106 is engaged, the disc may be “squeezed” between the flywheel and pressure plate, and power from the drum 52 may be transmitted by the disc's hub to the input shaft of the transmission.

The pressure plate may be a spring-loaded “clamp,” which may be bolted to the flywheel. It may include a sheet metal cover, release springs, a metal pressure ring that provides a friction surface for the clutch disc, a thrust ring or fingers for the release bearing, and release levers. The release levers lighten the holding force of the springs when the clutch is disengaged. The springs may be of a diaphragm-type, multiple coil type, or other type as will be appreciated by one of ordinary skill in the art. Some high-performance pressure plates are “semi-centrifugal,” meaning they may use small weights on the tips of the diaphragm springs to increase the clamping force as engine revolutions increase.

The “throw-out bearing” is the heart of clutch operation. When the clutch pedal is depressed, the throw-out bearing moves toward the flywheel, pushing in the pressure plate's release fingers and moving the pressure plate fingers or levers against pressure plate spring force. This action moves the pressure plate away from the clutch disc, thus interrupting power flow.

Mounted on an iron casting called a hub, the throw-out bearing slides on a hollow shaft at the front of the transmission housing. The clutch fork and connecting linkage convert the movement of the clutch pedal to the back and forth movement of the clutch throw-out bearing.

To disengage the clutch 106, the release bearing is moved toward the flywheel by the clutch fork. As the bearing contacts the pressure plate's release fingers, it begins to rotate with the pressure plate assembly. The release bearing continues to move forward and pressure on the release levers or fingers causes the force of the pressure plate's spring to move away from the clutch disc.

To engage the clutch 106, the clutch pedal is released and the release bearing moves away from the pressure plate. This action allows the pressure plate's springs to force against the clutch disc, engaging the clutch to the flywheel. Once the clutch 106 is fully engaged, the release bearing may be stationary and may prevent rotation with respect to the pressure plate.

A mechanical or hydraulic linkage may operate the clutch 106. A hydraulic clutch linkage may be similar to a mini hydraulic brake system. With a hydraulic mechanism, the clutch pedal arm operates a piston in the clutch master cylinder. This forces hydraulic fluid through a pipe to the clutch slave cylinder where another piston may operate the clutch disengagement mechanism. A master cylinder may be attached to the clutch pedal by an actuator rod, and the slave cylinder is connected to the master cylinder by high-pressure tubing. The slave cylinder is normally attached to a bracket next to the bell housing, so that it may move the clutch release fork directly.

Similar to depressing the brake pedal on your car, depressing the clutch pedal may push a plunger into the bore of the master cylinder. A valve at the end of the master cylinder bore closes the port to the fluid reservoir, and the movement of the plunger forces fluid from the master cylinder through the tubing to the slave cylinder. Since the fluid is under pressure, it is capable of causing the piston of the slave cylinder to move its pushrod against the release fork and bearing, thus disengaging the clutch.

When the clutch pedal is released, the springs of the pressure plate push the slave cylinder's pushrod back, which forces the hydraulic fluid back into the master cylinder. One of the advantages of a hydraulic linkage is the physics: a small amount of pedal force can be used to manipulate what would normally be a heavy clutch with a shaft and lever linkage.

As an alternative, instead of utilizing a hydraulic clutch 106, the system 10 may utilize a sprag clutch (not shown) and flywheel. A sprag clutch is a one-way freewheel metal roller clutch. It resembles a roller bearing with rollers shaped like a figure eight and cocked with a spring. When the unit rotates in one direction, the rollers stand up and bind because of friction, and when the unit is rotated in the opposite direction, the rollers slip or freewheel. The process of changing up gears involves preparing for the change by releasing a clutch that prevents the transmission from turning faster than the gear that it is currently in and engaging the sprag such that it is freewheeling. The gearchange occurs by engaging the higher gear through the sprag to change from freewheeling to driving.

Once the sprag has engaged drive in the higher gear, a clutch is engaged to place the transmission in that gear without the need for the sprag, which is then disengaged. By engaging and disengaging the various clutch packs within the transmission, one sprag can be used for all gearchanges. Depending on the relative rotating direction between inner and outer ring the clutch either transmits a friction-driven moment or detaches drive end and output end. It is to be understood that all roller bearings may be made out of any appropriate type of material, such as a synthetic composite.

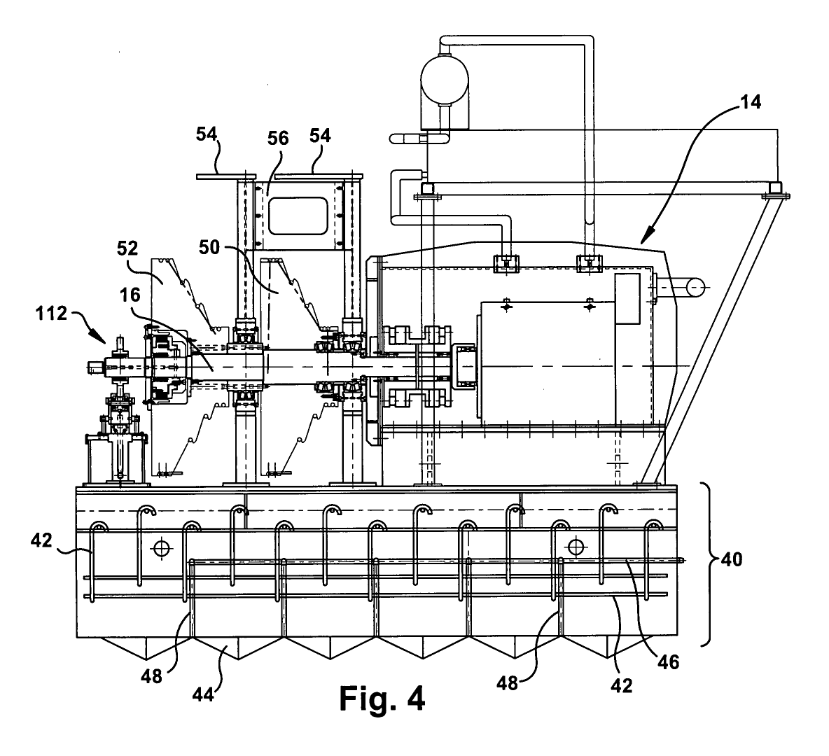

As shown in FIGS. 4, 5, 9 and 10, the system 10 may also include a guide plate 54. There may be any appropriate number of guide plates 54, but preferably there is the number of guide plates 54 as drums. In addition, the guide plates 54 may be of any appropriate shape and size, but are preferably of a rectangular shape and of a size equivalent to that of the angled portion of the conical drums 50, 52. As illustrated in FIG. 10, the guide plates 54 may include an end portion 53 and a guide rail 55. Preferably, there are two end portions 53 and two guide rails 55, but it is to be understood that there may be any appropriate number of end portions 53 and guide rails 55. The end portions 53 may be located at either end of the individual guide rails 55 to maintain the guide rails 55 in the appropriate spaced relation to one another.

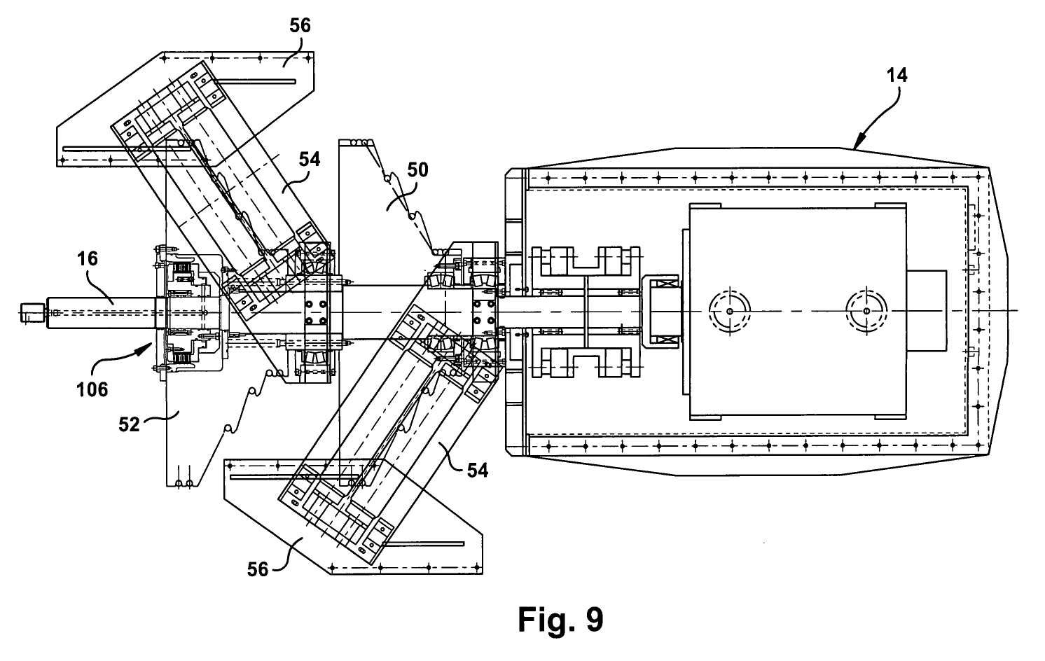

The rectangular guide plates 54 may guide the wires 36, 38 onto the conical drums 50, 52. The guide plates 54 may be bolted to the drum housing 56, where there may be one guide plate 54 for each drum 50, 52. The guide plates 54 guide the wires 36, 38 onto the appropriate step or location of the respective drum 50, 52. The guide plates 54 may be attached to the drum housing 56 at any appropriate location or angle, but are preferably located parallel to the platform 40 and above the drums 50, 52 near the top of the housing 56. The guide plates 54 are also preferably located at an angle that is similar to the outer conical shape of the drums 50, 52, as shown in FIG. 9.

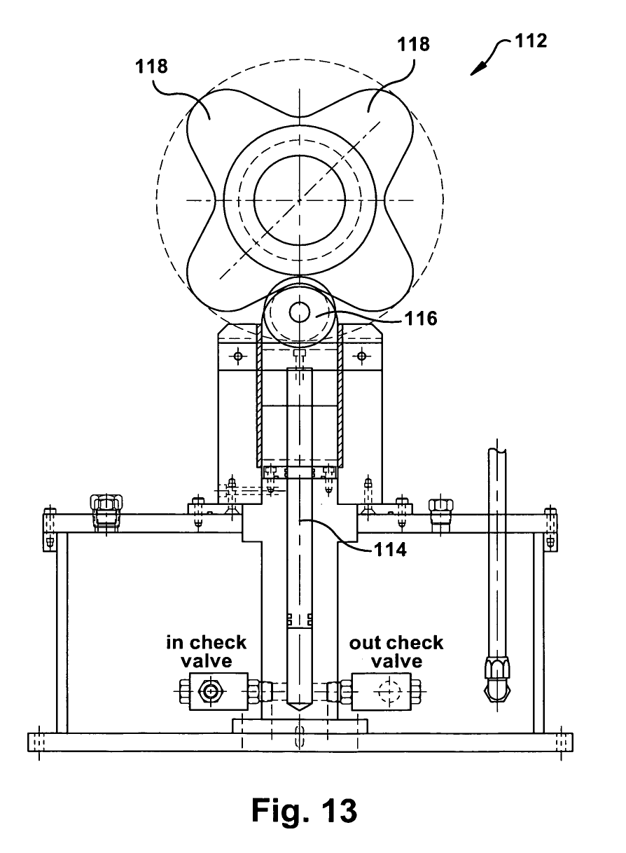

With reference to FIGS. 4, 7, and 13, the wave energy recovery system 10 may also include an oil pump 112. The oil pump 112 may be operated from and run off of the driveshaft 16. The oil pump 112 may include a piston 114, a piston ball 116, and a plurality of petals 118, as can be best seen in FIG. 13. As the shaft 16 spins, the petals 118 spin around, in a manner similar to a fan, for example, and push the piston ball 116 up and down, thereby moving the piston 114 up and down. Thus, the oil may be pressurized and sent through the system 10 due to this action of the piston 114.

As shown in FIG. 4, the generator 14 may be located on top of the platform 40. Preferably the generator 14 is located towards one end of the platform 40 and the drums 50, 52 are located toward the other end of the platform 40. Positioning the generator 14 on the seabed surrounds the generator 14 with water, which cools the generator 14 as it generates electric power. As generators 14 typically give off heat, providing a readily available method of cooling the generator 14 may increase the efficiency of the generator 14.

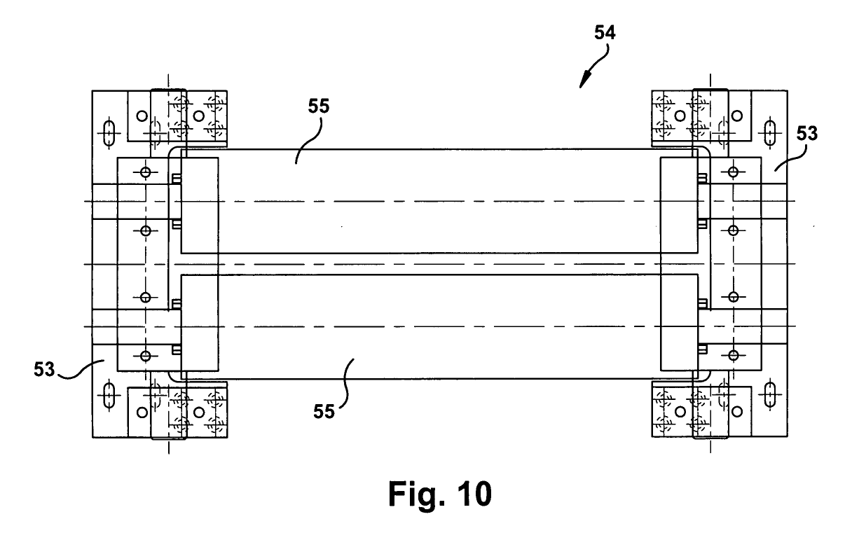

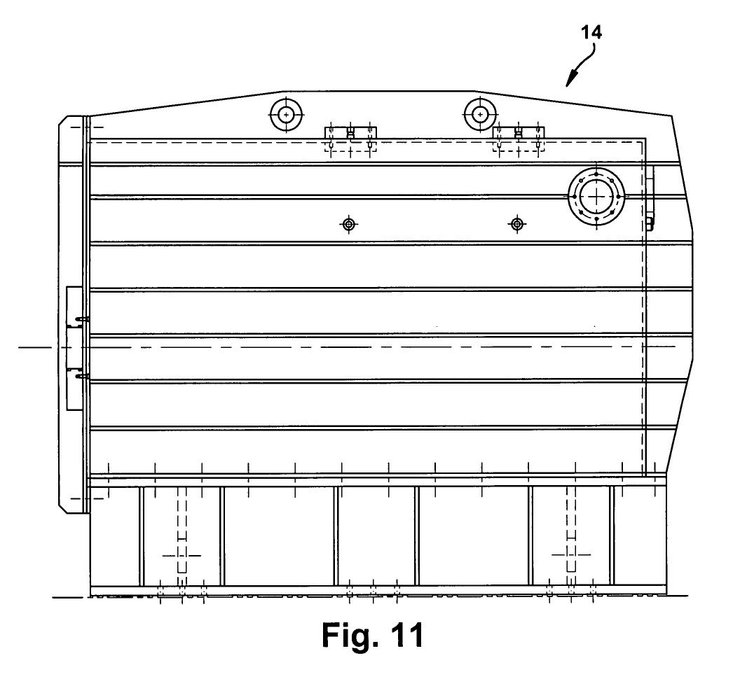

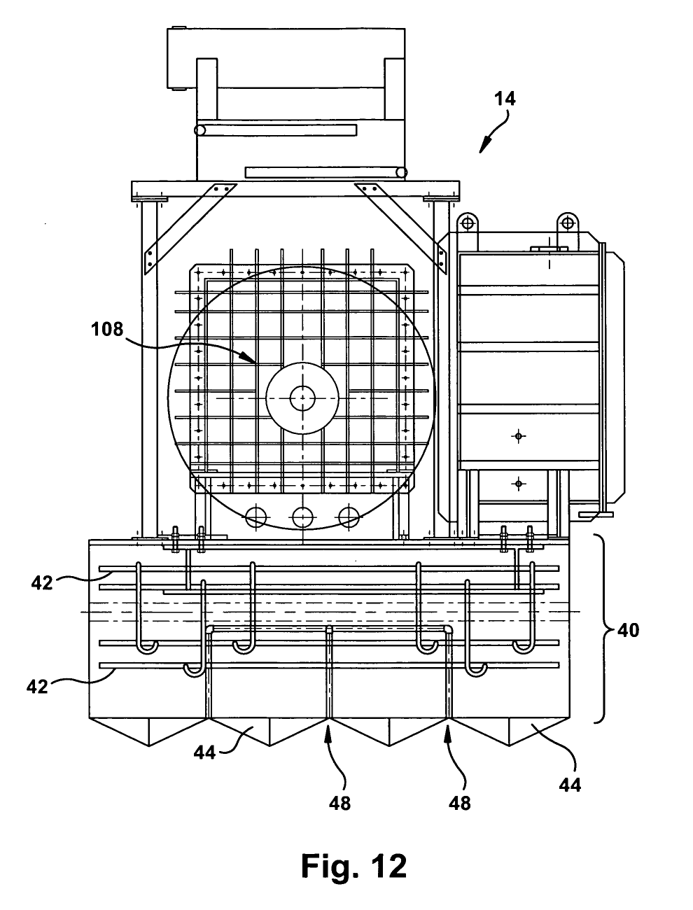

In addition, the wave energy recovery system 10 may also include a radiator or coolant system 108, as shown in FIGS. 11 and 12. The radiator 108 may be of any appropriate type. As the drums 50, 52 spin faster, the oil in the generator 14 can become very hot. As the oil is passed through the generator 14, the radiator 108 cools the oil, and then the oil may proceed back through the system 10 to the oil pump 16 to start its journey over.

As discussed above, each motion translating assembly 12 may be secured to a support platform 40 to maintain a static position with respect to the seabed. With reference to FIGS. 4 and 12, in an exemplary embodiment, the platform or base 40 may be constructed of concrete with a plurality of steel reinforcement bars or rebar 42 located throughout the platform 40 to aid in reinforcing the concrete platform 40. Preferably, the platforms 40 may be moveable from one location to another when it is desired to move the platform 40, but stable and stationary enough the remainder of the time so that they do not shift once placed on the ocean or seabed floor.

Thus, the platform 40 preferably has enough mass to maintain its position on the seabed and resist movement due to tides, thrust from the main buoy 20, storms, or other inclement weather. The platform may be of any appropriate shape and size, however, the support platform 40 is preferably a rectangular slab of concrete measuring ten feet in width, eight feet in depth, and four feet in height. Such a concrete slab may weigh approximately twenty-five tons and can withstand substantial forces without moving.

The platform 40 may also include diamond shaped pockets 44 on the underside of the platform 40 as well as airways 46, 48 throughout the platform 40. The diamond shaped pockets 44, which are approximately the shape of pyramids, may also be made out of cement. When the diamonds 44 are in contact with the sand, mud, etc. of the ocean or sea floor, the diamonds 44 may create suction cups that may prevent the base 40 from being able to pull away from the floor. The move the base 40, there may be vertical airways 48 within the base 40. When it is desired to move the platform 40, pressurized air is pushed through the horizontal side airway tube 46, the air is then pushed through airways 48 and out through the intersection of the diamond edges 44 of the base 40 that breaks the suction via the internal airways 46, 48.

The plurality of motion translating assemblies 12 may be arranged in any appropriate location or manner away from the shoreline, as illustrated in FIGS. 1-3. In an embodiment, the plurality of motion translating assemblies 12 may extend diagonally from the shoreline at any appropriate angle, such as an approximately 45-degree angle. In addition, the system 10 may include any appropriate number of assemblies 12, such as approximately thirty motion-translating assemblies 12. The assemblies 12 may be spaced at any appropriate distance from one another, such as being spaced approximately 30 feet apart. Such an arrangement generally results in each incoming wave raising and lowering each main buoy 20 at a different point in time.

As a wave progresses towards the shoreline, it may first encounter the motion translating assembly 12 located farthest off shore and raises and then lowers the translating assembly's 12 main buoy 20. Over time, the wave progresses through the plurality of assemblies 12 until it reaches the assembly 12 closest to the shore. Such an arrangement may be beneficial in that any single wave will not raise and lower the plurality of main buoys 20 at the same point in time, but will raise the plurality of main buoys 20 over a period of time. The raising of main buoys 20 over time as the wave progresses towards the shoreline causes different motion translating assemblies 12 to rotate the shaft 16 at different times, resulting in constant rotation of the shaft 16 at a generally constant speed and thus providing a constant supply of energy to the power grid.

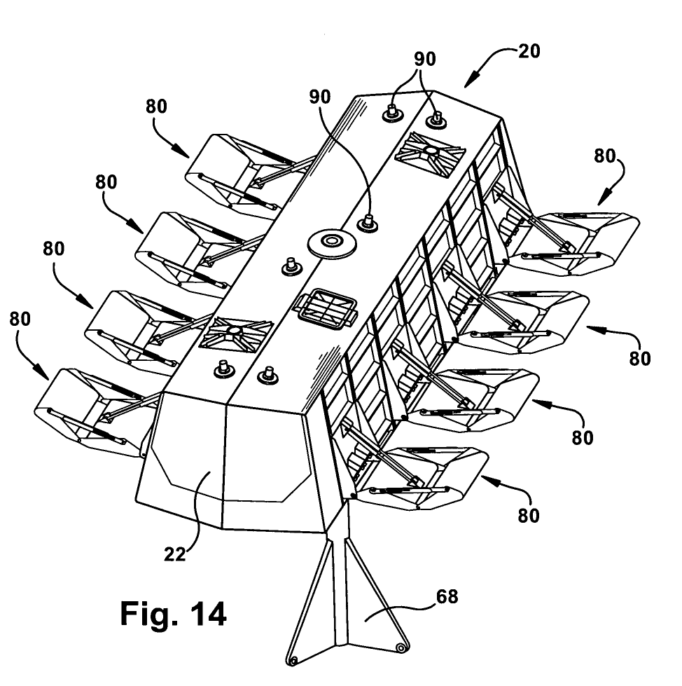

An embodiment of a main buoy 20 for use with a wave energy recovery system 10 is illustrated in FIGS. 14-20. The buoy 20 may include numerous features and sub-systems that improve the durability or service life of the system 10. In addition, the buoy 20 may include numerous features and subsystems for enhancing the overall efficiency and functionality of the system 10.

For example, the buoy 20 may include numerous features that provide for the dynamic positioning of the buoy 20 relative to the surface of the water. Minor adjustments in the position of the buoy 20 may increase the efficiency of the system 10 as the height and frequency of waves change. When violent storms or other such hazards are present, the buoy 20 may be selectively submerged below the surface of the water so as to reduce or eliminate damage to the buoy 20 or other system components. Once the storm passes or other such hazards subside, the buoy 20 may be returned to an operative position at or near the surface of the water.

The buoy 20 may be of any appropriate shape and size and may be made out of any appropriate material. The buoy 20 may be constructed from a metal frame and an aluminum skin. however, the buoys 20 may be constructed out of any appropriate material that allows the buoy 20 to float and rise and fall as waves pass. The main buoy 20 may be of any appropriate size, such as the approximate size of an automobile, for example. The buoy 20 may be unable to fall or tip over in the water due to its shape and size. The shape of the main buoy 20 may be of any appropriate shape or configuration capable of floating, such as a generally rectangular body, cylindrical body, or the like. While shown as of generally rectangular shape in the FIGURES, it is to be understood that this is not meant to be limiting in any way, and is for illustrative purposes only.

As illustrated in FIGS. 1, 15, and 17, the buoy 20 may be equipped with a plurality of connector cables 62 that are coupled at one end to the buoy 20 and are coupled at the other end to the main cable 36. The connector cables 62 may be coupled to the buoy 20 by any appropriate means. For example, the connector cables 62 may be coupled via connector rings (not shown), pistons (not shown), pivot connection, or the like. If the connector cables 62 are coupled to the buoy 20 by pistons, the pistons may be of any appropriate type, such as pneumatic pistons.

The pistons may be pressurized or depressurized to better position the buoy 20 with respect to the surface of the water. In one embodiment, a piston may be pressurized so as to affect the angel at which the buoy 20 is positioned with respect to the surface of the water. Placing the buoy 20 at an angle may provide for greater wave impact on the buoy 20 so as to increase the vertical displacement of the buoy 20, thus increasing the energy recovered by the buoy 20.

For example, the connector cables 62 may be coupled to the buoy 20 by a pivot connection 60 through which the buoy 20 is connected to the main cable 36. Three connector cables 62 may be attached to the pivot connection 60 on one end and attached to a pivot connection 60 on the other end. There may be a common ring 64 located at the bottom of a rigid member 66. The main cable 36 may be attached to the common ring 64 on one end and wrapped around the drums 50, 52 as previously described. In a preferred embodiment, the main cable 36 and the connector cables 62 are approximately ⅜ inch in diameter, with the connector cables 62 approximately 10 to 15 feet in length and the main cable 36 approximately 100 to 200 feet in length.

Referring again to FIGS. 1, 15, and 17, a rigid member 66, such as a pipe, may extend downward from the bottom 76 of the buoy 20, and at least one keel member 68 is attached to the pipe 66. Optionally, multiple keel members 68 may be attached to the pipe 66, but preferably, there are three keel members 68 attached to the pipe 66, each 120 degrees apart. The pipe 66 is preferably ten feet in length, and the keel members 68 are triangular shaped and three feet high and three feet wide. As a wave passes the buoy 20 the turbulence in the water is near the surface. The keel members 68 may be located at any appropriate position.

Positioning the keel members 68 approximately below the surface of the water, such as ten feet below the surface, for example, places avoids the turbulence of the wave. Such an arrangement provides stability to the buoy 20 and eliminates or reduces lateral movement, wobbling or rocking of the buoy 20. The elimination of such movement increases the vertical displacement of the buoy 20 and allows recovery of an increased percentage of a wave's energy.

A particular shape of the main buoy 20, such as a rectangular or cylindrical shape, for example, may produce greater thrust in the motion translating assemblies 12 and produce greater rotational motion of the shaft 16. A rectangular component placed in rough waters has a tendency to turn such that its longer vertical surface faces the incoming waves. By offering a greater surface area to incoming waves, the buoy 20 may catch more of the wave, thereby providing more thrust to the main cable 36 as the buoy 20 is moved upward by a passing wave. The rectangular buoy 20 may be of any appropriate size, such as thirty feet wide, ten feet deep, and five feet high, for example.

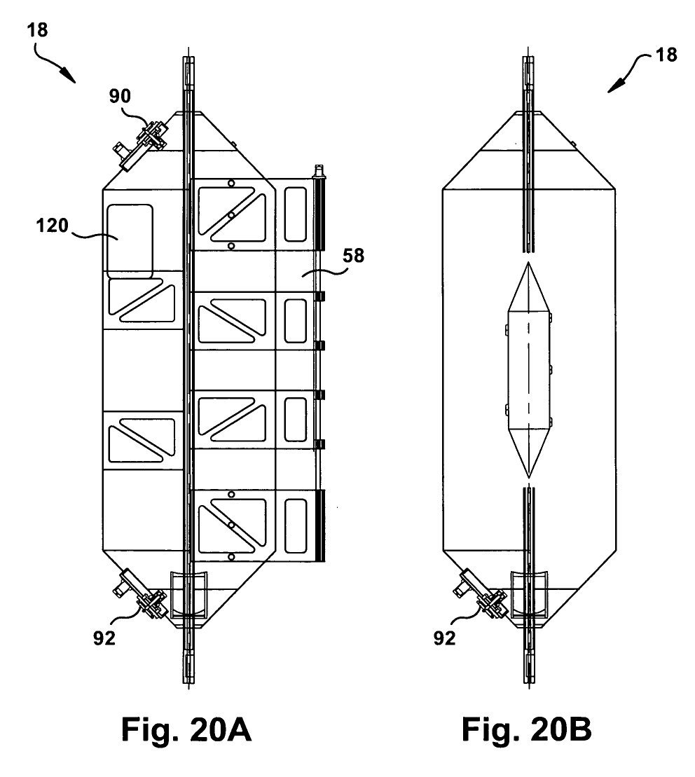

The retracting buoy 18, as best shown in FIGS. 1, 20A, and 20B, may be of any appropriate size and shape and may be made out of any appropriate material, such as being constructed from aluminum and being cylindrically shaped. The retracting buoy 18 may also include a guide sleeve 58. Similar to the main buoy 20, the retracting buoy 18 may also be equipped with a pair of valves 90, 92, such as an air inlet valve to intake air and expel water ballast, and a water inlet valve to intake water to increase water ballast. The retracting buoy 18 may also include a manhole or hatch 120 to give access to the inside of the retracting buoy 18 in case any repairs may need to be made. The bottom of the retracting buoy 18 may be attached to a cable 38 by any appropriate means, such as a ring or fastener.

The guide sleeve 58 may be attached to the side of the retracting buoy 18. The guide sleeve 58 may be arranged to slide along the cable 36 to maintain a controlled reciprocating motion as a wave progresses past the main buoy 20. In an embodiment, the retracting buoy 18 may be approximately 16 inches in diameter and 24 inches in height.

With respect to the cost of building traditional power plants, a wave energy recovery system 10 is very inexpensive to build and install. To install a system 10, components of the system 10 may be loaded onto pontoons or other such floating platforms. The pontoons may be evenly spaced along the surface of the water. The spacing of the pontoons may be approximately equal to the desired operative distance between installed support platforms 40 along the seabed. These assembled support platforms 40 may be lowered into position on the seabed from the pontoons, using any conventional means, such as chains or cables.

Once the drums 50, 52 are coupled to the shaft 16, the cables 36 and 38 may be wrapped around each drum 50 and 52 respectively, and a retracting buoy 18 may be attached to one end of the cable and the guide sleeve 58 installed along the cable. The free end of the main cable 36 may be attached to the common ring 64 and the length of the main cable 36 properly adjusted.

Each motion translating assembly 12 may be arranged to drive a shaft 16 attached to a generator 14 dedicated to that assembly 12. The motion translating assemblies 12 are arranged to drive dedicated generators 14 coupled to each support platform 40. However, a permanent magnet generator 14 is attached to each support platform 40. The vertical motion of the main buoy 20 is translated to rotational motion to rotate a driveshaft 16. The driveshaft 16 is coupled to and drives the generator 14, which produces electric power. The generated electric power can be delivered to shore, either for immediate use or to feed into a power distribution grid. Optionally, the electric power can be stored on the support platform 40 to be subsequently delivered to shore.

In an alternative embodiment, the electric power may be stored on the support platform 40 by coupling the generator 14 to a supercapacitor (not shown). Supercapacitors offer relatively high cycle lives, having the capacity to cycle millions of times before failing; low impedance; rapid charging; and no loss of capability with overcharging. A power cable 110 may be attached to each supercapacitor to deliver stored electric power to shore. As a wave passes the motion translating assemblies 12, some assemblies produce electric power, while others are momentarily idle. A programmable logic control device may optionally be incorporated into the system to control the generators 14 and other system components to delivery a consistent electrical current to the shore.

The driveshafts 16 may be arranged to only rotate in one direction or may optionally be arranged to rotate in both clockwise and counterclockwise directions. An AC permanent magnet generator may be arranged to generate electric power regardless of the direction the driveshaft 16 rotates. Generators 14 may also be arranged to eliminate any need for a gearbox when generating electric power. The system 10 may be arranged such that each dedicated generator 14 has a dedicated power cable 110 to deliver electric power to shore. The electric power generated by the plurality of generators 14 may be accumulated on shore and delivered to a power distribution grid.

The use of dedicated generators 14 secured to each support platform 40 allows for easy installation of the wave energy recovery system. The wave energy recovery system 10 may be secured to the ocean floor by a support platform 40. As discussed above, the support platform 40 may be a concrete slab with enough mass to maintain its position on the ocean floor and resist movement due to tides, thrust from the main buoy 20, storms, or other inclement weather.

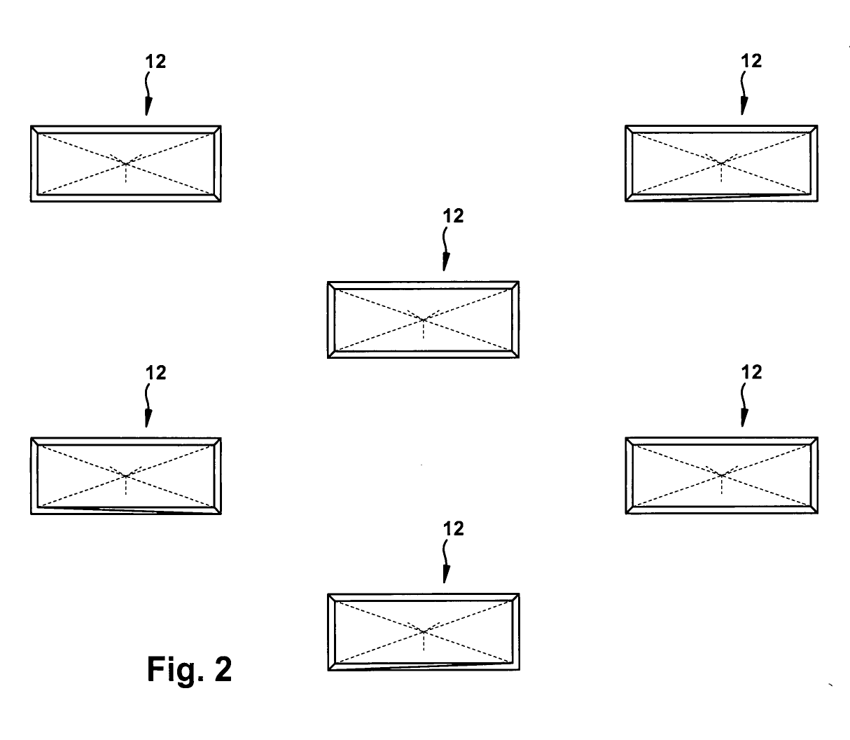

As illustrated in FIG. 2, support platforms 40 may be placed randomly, without concern for the positioning of adjacent platforms 40. Each motion translating assembly 12 and dedicated generator 14 is self-sufficient and does not rely on adjacent assemblies 12. Flexible power cables 110 allow a generator 14 or supercapacitor to deliver electric power to shore from nearly any location on the seabed, either in series or in parallel.

As illustrated in FIGS. 14-20, the buoy 20 includes a generally hollow hull or body 22. The body 22 optionally may be internally supported by beams (not shown) or others such structural members. The body 22 may be arranged to include a number of generally flat surfaces such as, for example, a pair of top surfaces 24, a pair of side surfaces 26, a pair of front surfaces 28, a pair of back surfaces 30, and a pair of bottom surfaces 32.

The pair of top surfaces 24 may be arranged at an angle to one another so that a peak is formed between the pair of top surfaces 24. Such a peak will encourage rain or other such precipitation to run off the top surfaces 24, thus discouraging the pooling of water on the top surfaces 24. The side 26, front 28, and back 30 surfaces of the buoy 20 each may be arranged at an angle with respect to a vertical plane.

Such an arrangement may limit lateral movement of the buoy 20 and enhance vertical movement of the buoy 20 as waves impact the front, back, and sides of the buoy 20. For example, as a wave impacts the front, back, or sides of the buoy 20, the angled surface of the buoy 20 causes a portion of the energy of the wave to encourage the buoy 20 to be displaced vertically.

In another example, as a wave washes over the buoy 20, the portion of the wave washing over the buoy 20 may commonly impact the opposing side of the buoy 20. When the side is positioned at an angle to a vertical plane, the portion of the wave washing over the buoy 20 may encourage the buoy 20 downward. In addition, the wave washing over the buoy 20 encourages the buoy 20 to move laterally back toward the direction from which the waves originated, thus offsetting the lateral movement of the buoy 20 due to the initial impact of the wave. Upon studying the description and FIGURES provided herein, it will be readily understood by those skilled in the art that arranging the side, front, and back surfaces at an angle relative to a vertical plane may facilitate the vertical movement of the buoy 20 and decreases the lateral movement of the buoy 20.

The pair of bottom surfaces 32 may be arranged at an angle to one another so as to form a generally concave bottom. Such an arrangement may promote the stability of the buoy 20 by reducing or eliminating wobbling or other such oscillation of the buoy 20 as waves impact the buoy 20. The buoy 20 may also include a skirt 34 extending from the bottom surfaces 32 of the buoy 20. The skirt 34 may be of any appropriate shape, size and material. The positioning and shape of the skirt 34 may further reduce or eliminate any undesired lateral movement, wobbling, and rocking of the buoy 20. The shape of the skirt 34, in cooperation with the downward forces produced by the main cable 36, may hold the buoy 20 level on the surface of the water as a wave passes. As the wave displaces the buoy 20 upward, the buoy 20 remains level, thus reducing or eliminating any undesired lateral movement, wobbling, or rocking Maximizing the vertical movement of the buoy 20 also maximizes the energy recovered from a wave.

The main buoy 20 may further be equipped with valves, such as an air inlet valve 90 and a water inlet valve 92. The buoy 20 may also include valves 90, 92 located in the top and bottom sides 24, 32 of the buoy 20. There may be any appropriate number of valves 90, 92, but there are preferably six (6) valves 90 located on the top 24 of the buoy 20 and six (6) valves 92 located on the bottom 32 of the buoy 20. The top valves 90 allow air in to raise the buoy 20 and the bottom valves 92 allow water in to sink the buoy 20, thereby steadying the buoy 20 with ballast. The buoy 20 is intended to float near the top of the water in order to receive the effect of the waves. The water within the buoy 20 may be kept at any appropriate level, but is preferably maintained at about ⅛″ around the bottom of the buoy 20. The air and water levels from the valves within the buoy 20 may be electronically regulated.

The valves 90, 92 may be operated by any appropriate means, but are preferably remotely operated. The valves 90 and 92 may be remotely controlled to take in water through the water inlet valve 92 for additional ballast to stabilize the floating position of the buoy 20, or to take in pressurized air through the air inlet valve 90 to expel water and reduce water ballast in the buoy 20. The valves 90, 92 may be arranged such that the buoy 20 may take on enough water ballast to completely submerge the buoy 20.

The buoy 20 may also include a series of valves 90, 92 provided to allow fluids to enter and exit the hull 22 of the buoy 20. In one embodiment, six valves 90 are located along the top surfaces 24 of the buoy 20, and six valves 92 are located along the bottom surfaces 32 of the buoy 20. Such an arrangement may provide for the intake and expulsion of fluids from the hull 22 of the buoy 20.

In one example, the topside valves 90 may be arranged so as to allow atmospheric air into the hull 22 of the buoy 20 and may be arranged so as to allow the expulsion of atmospheric air from the hull 22 of the buoy 20. In another example, the bottom-side valves 92 may be arranged so as to allow water from the surrounding body of water into the hull 22 of the buoy 20 and may be arranged to allow for the expulsion of water from the hull 22 into the surrounding body of water.

Through such arrangements, the amount of water in the hull 22 may be controlled and, thus, the amount of ballast in the hull 22 may be controlled. The amount of ballast in the hull 22 may be used to control the location of the buoy 20 with respect to the surface of the water. Controlling the location of the buoy 20 with respect to the surface of the water may allow the buoy 20 to be submerged to protect the buoy 20 from inclement weather. Such control also may allow for precisely locating the buoy 20 with respect to the surface of the water to increase the efficiency of energy recovery from passing waves.

Valves 90, 92 such as those described herein may be arranged to open or close through the application of mechanical forces on the valves 90, 92. In one example, the valves 90, 92 may be coupled to a spring 150 or other such biasing member to encourage the valves toward either an open or a closed position. In another example, the valves 90, 92 may be coupled to a pneumatic member, such as a pneumatic cylinder, to selectively encourage a valve into either an open or closed position. It will be readily understood from this description and accompanying illustrations that a valve may be coupled to both a biasing member and a pneumatic member to selectively open and close valves. In addition, it will be understood that other forces, such as gravity, surrounding environmental pressures, hydraulic pressure, and the like, may be utilized to encourage a valve into a desired position.

With regard to the surrounding environment being utilized to assist in the opening or closing of the valves 90, 92, in one example the buoy 20 may be designed such that fluid pressure from the surrounding body of water may be utilized to encourage a valve into an open or a closed position. Similarly, a buoy 20 may be designed such that pressure from the surrounding atmosphere may be utilized to encourage a valve into an open or a closed position. Such environmental forces may be accounted for in the design of valves, springs, pneumatic members, and the like so as to ensure the formation of effective valves.

In one embodiment, a pneumatic system 70 may be incorporated into a buoy 20 to selectively open and close the valves 90, 92. The valves 90, 92 may be coupled on the outer edge of the body or hull 22 of the buoy 20. The pneumatic system may include air inlet and outlet valves 90, 92, a plunger valve 148 and a return tank 144. The plunger valve 148 may include a plunger 146, a spring 150, an air hole 152a, a piston 154a, and an inlet/outlet 156. The return tank 144 may include an air hole 152b and a piston 154b. The air hole 152b of the return tank 144 may be in communication with the valve 90, 92.

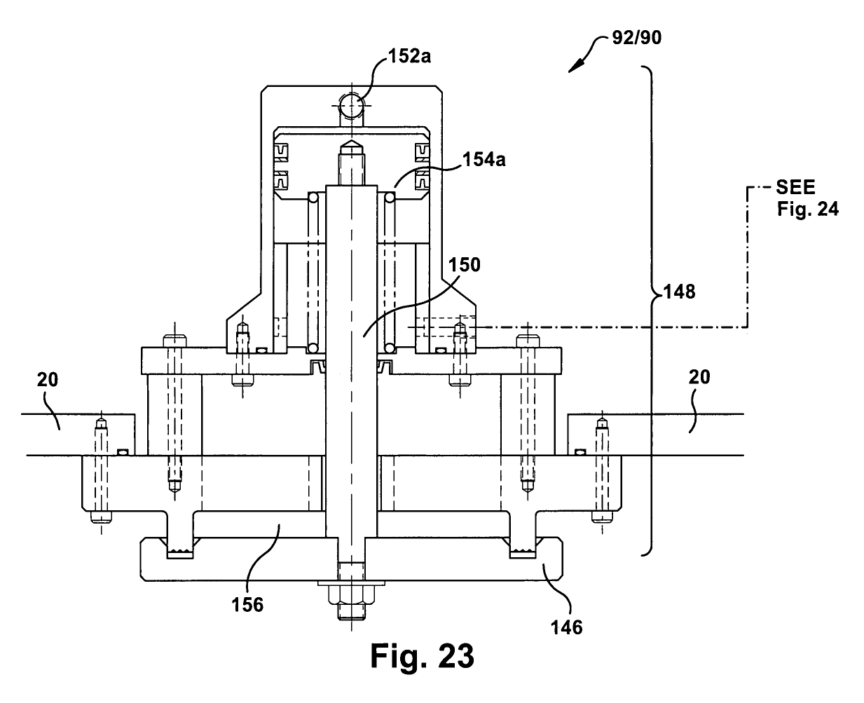

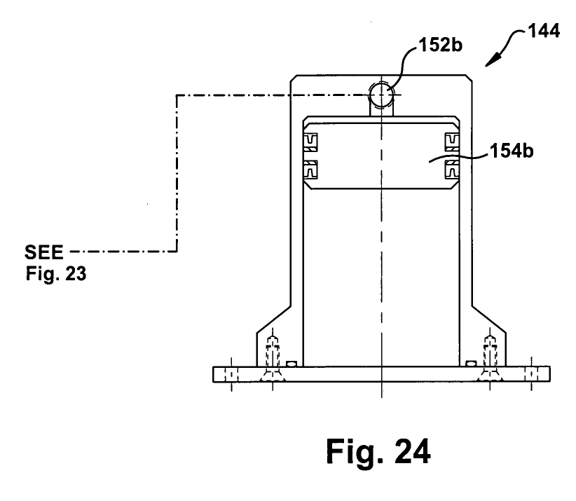

For example, as shown in FIGS. 23 and 24, as the valve 92 pushes the spring 150 down to open the plunger 146, air is pushed down and sent to the return tank 144. The air sent to the return tank 144 pushes down the piston 154b thereby creating a pressurization of the tank, which may aid in closing the plunger 146 as the displaced air in the return tank 144 forces the piston 154b back to its original position, as shown in FIG. 24.

The plunger valve 148 may be coupled to a source of pressurized gas that may selectively pressurize the plunger valve 148. The selection to pressurize the valves 90, 92 may be driven by computer logic and controls located in any appropriate place, such as either on the buoy 20, near the buoy 20, or remotely from the buoy 20, for example. The spring 150 may be located within the approximate center of the plunger valve 148. The spring 150 may be of any appropriate type, but is preferably an approximate seventy-pound (70 lb.) spring. The plunger 146 may face any appropriate direction, but preferably faces an outward direction.

In one embodiment, the pneumatic system may be arranged such that, when the plunger valve 148 is pressurized, a bottom-side valve 92 is encouraged into the open position, as shown in FIG. 23. Such an arrangement may facilitate the filling of the hull 22 with water from the surrounding body of water. Once the plunger 146 is in the closed position, water may be prevented from entering the buoy 20.

As an alternative, as illustrated in FIG. 33, pneumatic systems 70 may be incorporated into a buoy 20 to selectively open and close the valves 90, 92. A pneumatic system 70 may include a spring 72 and a pneumatic cylinder 74, wherein each pneumatic cylinder 74 may be coupled on one end to the door of a valve 90, 92 and may be coupled on the other end to the body or hull 22 of the buoy 20. The pneumatic cylinder 74 may be coupled to a source of pressurized gas that may selectively pressurize the cylinder 74. The selection to pressurize the cylinder 74 may be driven by computer logic and controls located either on the buoy 20, near the buoy 20, or remotely from the buoy 20.

The pneumatic cylinder 74 may be arranged such that, when the cylinder 74 is pressurized, a bottom-side valve 92 is encouraged into the open position. The spring 72 may be arranged such that the spring 72 encourages the bottom-side valve 92 into the closed position to assist in closing the valve 92 when the cylinder is selectively depressurized or in the event that the pneumatic cylinder 74 or the logic driving the cylinder 74 fails. Such an arrangement may facilitate the filling of the hull 22 with water from the surrounding body of water.

When a system operator or computer logic determines that it is desirable to submerge the buoy 20 due to inclement weather or other such hazard, one method of submerging the buoy 20 is to fill the hull 22 with enough water to overcome the buoyancy of the buoy 20, thereby submerging the buoy 20. As the bottom-side valves 92 are commonly in contact with the body of water, the environmental pressures tend to hold the valves 92 in the closed position. Such environmental pressures, along with the arrangement of the spring 72, serve to seal the bottom-side valves 92 such that the valves 92 normally resist water entering the hull 22. However, when it is desirable to open the valves 92 and allow water to enter the hull 22, the pneumatic cylinder 74 is pressurized to overcome the environmental pressures and the spring force to open the valves 92. When sufficient water has entered the hull 56 to submerge the buoy 20 to its desired depth, the pneumatic cylinders 74 may be depressurized, and the spring 72 may return the valve 92 to its closed position. The buoy 20 may include a depth meter (not shown) to assist in determining when the buoy 20 reaches the desired depth.

With further reference to FIG. 33, the pneumatic cylinder 74 may be arranged such that, when the cylinder 74 is pressurized, a topside valve 90 is encouraged into the closed position. The spring 72 may be arranged such that the spring 72 also encourages the topside valve 90 into the closed position so that the valve remains closed when the cylinder 74 is selectively depressurized. Maintaining the valve 90 in the closed position may seal the hull 22 so that rain or other moisture is not permitted to enter the hull 22.

The closing of the topside valves 90 by pressurizing the cylinder 74 may assist in facilitating the expulsion of water from the hull 22 through the bottom-side valves 64. When a system operator or computer logic determines it is desirable to return the buoy 20 from a submerged position to an operative position at the surface of the water, the buoy 20 may be raised by expelling water from the hull 22 back into the surrounding body of water so as to increase the buoyancy of the buoy 20.

One method of expelling water from the buoy 20 is to close and seal the topside valves 90, open the bottom-side valves 92, and pressurize the hull 22 such that the water in the hull 22 flows out of the bottom-side valves 92 and back into the surrounding body of water. The cylinders 74 may be pressurized so as to apply a substantial force on the doors of the topside valves 90, thereby sealing the valves 90, i.e., holding the valves 90 closed against the internal pressure building in the hull 22 that is used to expel the water.

Once the water is expelled from the hull 22, the cylinders 74 coupled to the topside valves 90 may be depressurized, and the springs 72 coupled to the topside valves 90 may apply a sufficient force to the door of the topside valve 90 to maintain the valve 90 in a closed position so as to keep unwanted moisture out of the hull 22. In another embodiment, the springs 72 coupled to the topside valves 90 apply a sufficient force to maintain the valve 90 in a closed position, but also allow the valve 90 to serve as a release valve that vents pressure that may develop in the hull 22 during the operation of the wave energy recovery system 10.

A complete submersion of the buoy 20 may be desirable to reduce or eliminate damage to the buoys 20 or other system components when violent storms or other such hazards are present. Once a storm passes, the buoy 20 may take in pressurized air through the air inlet 90 to expel water ballast and return the buoy 20 to its operative position. Furthermore, the main buoy 20 may be adjustably raised or lowered through the intake and expulsion of water ballast to dynamically adjust the buoy 20 position in response to changing wave conditions to maintain optimal operative positioning for the buoy 20.

Ballast is used to provide moment to resist the lateral forces on the buoy 20. If the buoy 20 is insufficiently ballasted it will tend to tip, or heel, excessively in high winds. Heeling may occur when there is too much wind or water pressure to one side, thereby causing the buoy 20 to lean over to one side. In addition, too much heel may result in the buoy 20 flipping over or out of its preferred position in relation to the waves. Adding water ballast below the vertical center of gravity increases stability. When the buoy 20 heels, it must then lift the ballast clear of the water, at which point it is obvious that it does provide righting moment. One advantage of water ballast is that it can be dumped out by having a valve at the bottom of the ballast chamber, reducing the weight of the buoy 20, and then added back in by opening up the valves and letting the water flow in after the buoy 20 is back in its ideal position.

When a system operator or computer logic determines that it is desirable to submerge the buoy 20 due to inclement weather or other such hazard, one method of submerging the buoy 20 is to fill the hull 22 with enough water to overcome the buoyancy of the buoy 20, thereby submerging the buoy 20. As the bottom-side valves 92 are commonly in contact with the body of water, the environmental pressures may tend to hold the valves 92 in the closed position. Such environmental pressures, along with the arrangement of the spring 150, serve to seal the bottom-side valves 92 such that the valves 92 normally resist water entering the hull 22.

However, when it is desirable to open the valves 92 and allow water to enter the hull 22, the plunger valve 148 is pressurized to overcome the environmental pressures and the spring force to open the valves 92. When sufficient water has entered the hull 22 to submerge the buoy 20 to its desired depth, the plunger valves 148 may be depressurized, and the spring 150 may return the valve 92 to its closed position. The buoy 20 may also include a depth meter (not shown) to assist in determining when the buoy 20 reaches the desired depth.

In one embodiment, a plunger valve 148 is arranged such that, when the plunger valve 148 is pressurized, a topside valve 90 is encouraged into the closed position. The spring 150 may be arranged such that the spring 150 also encourages the topside valve 90 into the closed position so that the valve remains closed when the cylinder 74 is selectively depressurized. Maintaining the valve 90 in the closed position may seal the hull 22 so that rain or other moisture is not permitted to enter the hull 22.

The closing of the topside valves 90 by pressurizing the plunger valves 148 may assist in facilitating the expulsion of water from the hull 22 through the bottom-side valves 92. When a system operator or computer logic determines it is desirable to return the buoy 20 from a submerged position to an operative position at the surface of the water, the buoy 20 may be raised by expelling water from the hull 22 back into the surrounding body of water so as to increase the buoyancy of the buoy 20.

One method of expelling water from the buoy 20 is to close and seal the topside valves 90, open the bottom-side valves 92, and pressurize the hull 22 such that the water in the hull 22 flows out of the bottom-side valves 92 and back into the surrounding body of water. The plunger valves 148 may be pressurized so as to apply a substantial force on the doors of the topside valves 90, thereby sealing the valves 90, i.e., holding the valves 90 closed against the internal pressure building in the hull 22 that is used to expel the water.

Once the water is expelled from the hull 22, the plunger valves 148 coupled to the topside valves 90 may be depressurized, and the springs 150 coupled to the topside valves 90 may apply a sufficient force to the door of the topside valve 90 to maintain the valve 90 in a closed position so as to keep unwanted moisture out of the hull 22. In another embodiment, the springs 150 coupled to the topside valves 90 apply a sufficient force to maintain the valve 90 in a closed position, but also allow the valve 90 to serve as a release valve that vents pressure that may develop in the hull 22 during the operation of the wave energy recovery system 10.

The methods of affecting buoyancy through intake and expulsion of water from the hull 22 described above may be used to either submerge or raise a buoy 20 or precisely position a buoy 20 at the surface of the water. Precise positioning of a buoy 20 at the surface of the water may increase the efficiency of the system with regard to recovery of energy, safety, etc. Other methods of precise positioning of the buoy 20 may include the use of pressure chambers 76 located on the buoy 20. In addition, it is also preferable that the inside of the buoy 20 maintains a certain amount of pressurized air. Any appropriate amount of pressurized air may be used, such as maintaining a pressure of three psi within the buoy 20. Maintaining the buoy 20 full of pressurized air may aid in maintaining the buoyancy of the buoy 20.

The buoy 20 may also include at least one cylinder or tank 76, but preferably six tanks located at any appropriate location on the buoy 20, but preferably located along an outer edge of the buoy 20. Five of the tanks 76 may include ballast air from the paddle mechanism 80. When the paddles 82, 84 move to stabilize the buoy 20, the paddles 82, 84 may push air into the ballast air tanks 76. The sixth and last tank 76 may be a control tank that provides air that may be used to open and control valves 90, 92.

As illustrated in FIG. 19, a plurality of pressure chambers or tanks 76 may be distributed along the bottom side of the buoy 20. In one example, a pressure chamber 76 may be arranged as an elongated tube positioned in the hull 22 and running along the inner surface of the bottom side of the hull 22. Although pressure chambers 76 are described and illustrated as running along the bottom side of the hull 22, it will be readily appreciated by those skilled in the art that pressure chambers may be distributed anywhere throughout the buoy 20. For example, pressure chambers may be located along the internal surfaces of the topside, as illustrated in FIG. 33, along internal surfaces of the sides of the hull, or within structural members supporting the hull.

Pressurizing the pressure chambers 76 to different pressures may control the buoyancy of the buoy 20. Increasing the buoyancy will generally raise the position of the buoy 20 with respect to the surface of the water. Decreasing the buoyancy will generally lower the position of the buoy 20 with respect to the surface of the water. As will be subsequently discussed herein, mechanical systems attached to the buoy 20 may be utilized to pressurize the pressure chambers 76. Computer logic or system operators may determine that a change in the buoy's 20 position relative to the surface of the water will increase the efficiency of the system 10. The computer logic or system operator then may increase the pressure in the chambers 76 or may decrease the pressure in the chambers 76 so as to affect buoyancy and more optimally position the buoy 20.

The pressure chambers 76 may be further utilized as a source of pressurized gas to control other systems or functions of the buoy 20. In one example, the pressure chambers 76 may be used as a source of pressurized gas for pressurizing the pneumatic system 70 so as to move valves 90, 92 to open and closed positions, as described herein. In another example, pressurized gas in the pressure chambers 76 may be used so as to pressurize the hull 22 such that water is expelled from the hull 22 when it is desirable to return a submerged buoy 20 to the surface of the water.

The buoy 20 may further include at least one paddle mechanism 80. The paddle mechanism(s) 80 may be located at any appropriate location on the buoy 20, but preferably located on its side(s) 26. The paddle mechanisms 80 may help to stabilize the buoy 20 by keeping the largest face of the buoy 20 on the wave so that the buoy 20 rises and falls horizontally.

The paddle mechanisms 80 may include an inner paddle 82, and outer paddle 84, and a main piston 86, and an adjustment piston 88. The pair of paddle members 82, 84 may be coupled by a hinge pin 94 such that the paddles 82, 84 may be adjusted to positions at varying angles relative to one another. The paddle mechanisms 80 may also pump air within the buoy 20 so that the buoy is filled with pressurized air to keep the buoy 20 stationary. Preferably, during operation of the system 10 the buoy 20 should not move above eighteen feet due to the waves. The buoy 20 moves approximately three to four feet up and down with the waves all the time.

The positioning and shape of the paddle mechanisms 80 also tend to eliminate or reduce lateral movement, wobbling, and rocking of the buoy 20. The shape of the paddles 82, 84, in cooperation with the downward forces produced by the main cable 36 and connector cables 62, holds the buoy 20 level on the surface of the water as a wave passes. As the wave displaces the buoy 20 upward, the buoy 20 remains level, thus reducing or eliminating lateral movement, wobbling, and rocking As described above, maximizing vertical movement also maximizes the energy recovered from a wave.

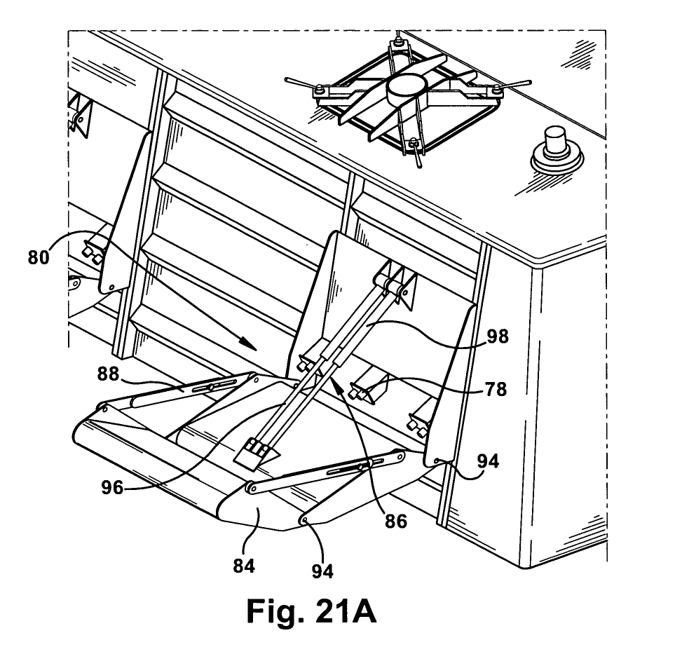

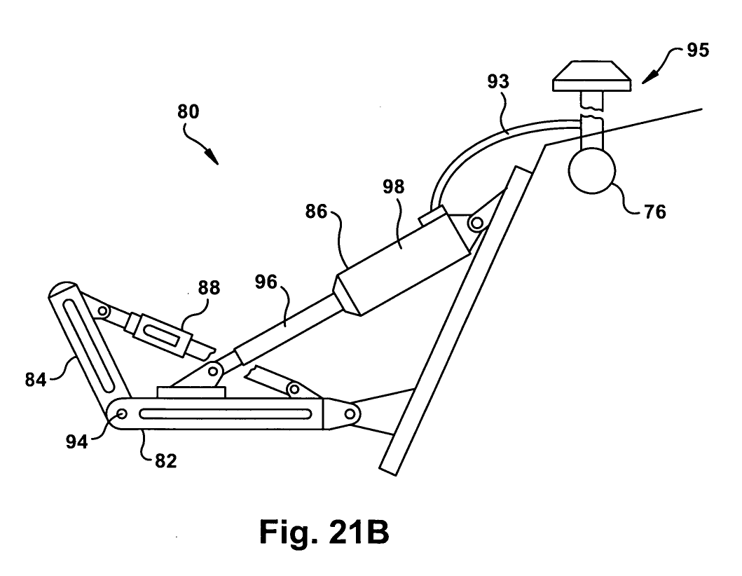

Mechanical systems attached to the buoy 20 may be utilized to pressurize the pressure chambers 76. One exemplary embodiment of such a mechanical system is illustrated in FIG. 21A. FIG. 21A illustrates a paddle compression mechanism 80 for pressurizing the pressure chambers 76 of the buoy 20. Each paddle mechanism 80 may include an inner paddle flap 82 and an outer paddle flap 84. Each of the paddle flaps or members 82, 84 may be adjustable in order to achieve the maximum power from each wave. The paddle compression mechanism 80 utilizes mechanical movements caused by the interaction of the paddle mechanism 80 with waves in order to generate pressure and to deliver that pressure to the pressure chambers 76.

As discussed above, the inner paddle 82 may be connected to the buoy 20 by a hinge pin 94 so that the inner paddle 82 may be adjusted to positions at varying angles relative to the side 26 of the buoy 20. The adjustment piston 88 is coupled to both paddles 82, 84 such that the expansion or contraction of the adjustment piston 88 controls the positioning of the paddle members 82, 84 relative to each other. The length of the adjustment piston 88 may be rigidly set such that the relative position of the paddles 82, 84 is rigid or otherwise static.

In one embodiment, the paddles 82, 84 may be positioned such that inner paddle 82 is generally positioned at the surface of the water and parallel to the surface of the water. The outer paddle 84 is positioned above the surface of the water and at an acute angle to the surface of the water. Such an arrangement may maximize the impact force of a passing wave on the paddle mechanism 80.

The paddle 82 at a location parallel to the surface of the water may be positioned so as to recover the energy of the vertical or upward movement of a passing wave. The paddle 84 located at an acute angle to the surface of the water may be positioned so as to recover the energy of the lateral movement of the passing wave. The paddle mechanism 80 may also include rubber stops 78 to prevent the outer paddle 84 from slamming against the inner paddle 82 in cases of rough water or when the operator desires to fully fold the outer paddle 84 up to the inner paddle 82, for example.

The main piston 86 may be coupled on a first end to a paddle member 82 and is coupled on a second end to the body of the buoy 20. As will be readily appreciated, upward movement of the paddle members 82, 84 may cause the piston shaft 96 to move and to pressurize the piston cylinder 98. As an alternative, and as illustrated in FIG. 21B, a fluid line 93 may be coupled the piston cylinder 98 to an intake manifold 95, and the intake manifold 95 may be coupled to a pressure chamber 76 that is positioned within the buoy 20.

The fluid line 93 may couple the piston cylinder 98 in fluid communication with the pressure chamber 76 such that the pressure generated in the piston cylinder 98 by the movement of the paddles 82, 84 is relayed or otherwise communicated to the pressure chamber 76. It will be readily appreciated that, as waves impact the paddles 82, 84 and repeatedly move the paddles 82, 84, the pressure chamber 76 may be continuously pressurized during normal operation of the buoy 20.

In an embodiment, the buoy 20 may be arranged so as to have a plurality of paddle compression mechanisms 80, with each mechanism 80 pressurizing one or more pressure chambers 76 located within the hull 22 of the buoy 20. In an embodiment, eight paddle compression mechanisms 80 are arranged on the buoy 20, with one mechanism 80 on each side surface 26 of the buoy 20. In addition, each mechanism 80 may be arranged such that it may generally slide vertically along the surface of the buoy 20. Such an arrangement facilitates the desirable positioning of the paddles 82, 84 relative to the surface of the water.

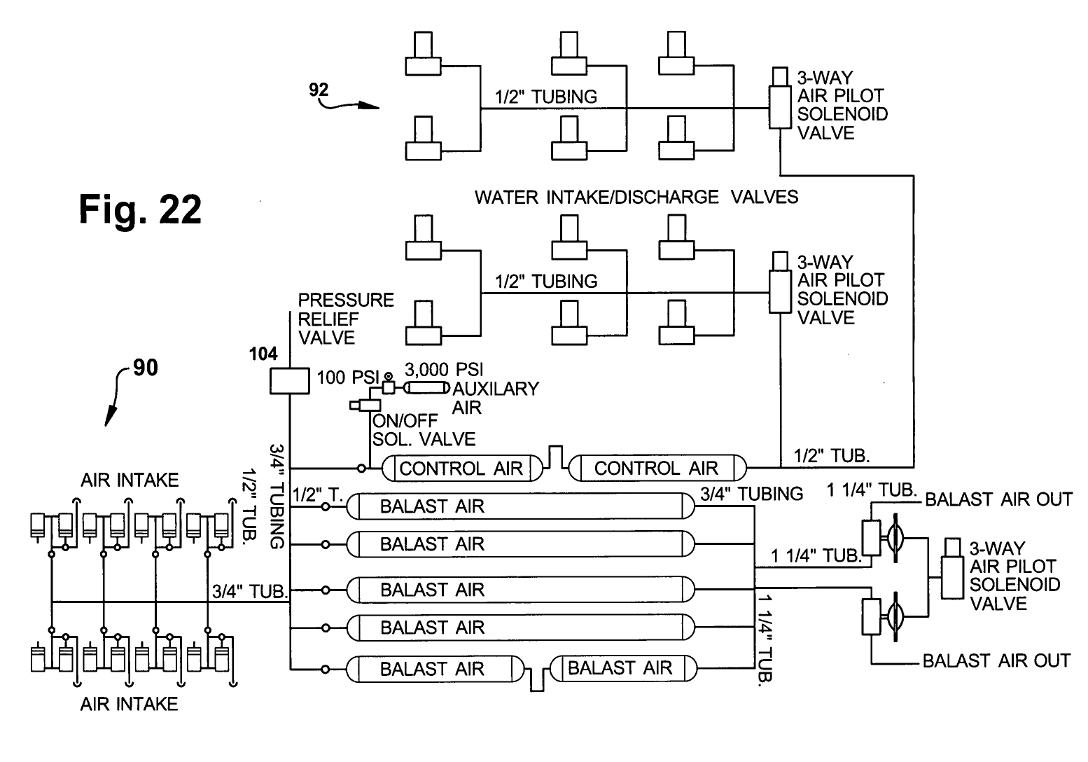

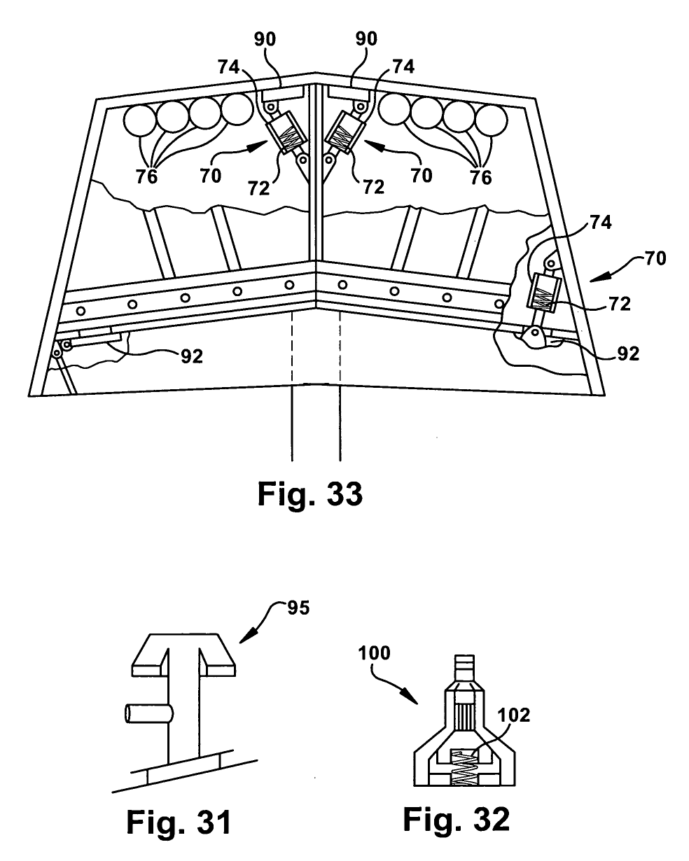

As shown in FIG. 31, the intake manifold 95 may be arranged so as to regulate the pressure in a pressure chamber 76 and to block water from entering the pressure chamber 76. The manifold 95 may be arranged with a relief valve 104 to release air from the pressure chamber 76 if the pressure in the chamber 76 rises above a predetermined level, as shown in FIG. 22. For example, it may be determined that the maximum desirable pressure in a pressure chamber 76 is 125 psi. The relief valve 104 may be arranged to release air from the pressure chamber 76 whenever the pressure in the chamber 76 rises above 125 psi.

The manifold 95 may include an oil pan (not shown) that is filled with oil or another similar liquid substance. The oil and the oil pan may be arranged such that air released from the pressure chamber 76 may pass through the oil in the oil pan and be released to the surrounding environment. The oil and the oil pan may also be arranged to as to block or otherwise prevent water from the surrounding environment from passing through the manifold 95 and into the pressure chamber 76. The oil used in the oil pan may be a vegetable oil, fish oil, or other appropriate organic substance that would not cause any environmental issues in the event that the oil is spilled into the environment surrounding the buoy 20.

As shown in FIG. 32, the paddle compression mechanism 80 may further include a check valve 100. The check valve 100 may be located anywhere along the fluid path between the main piston 86 and the pressure chamber 76. In one embodiment, the check valve 100 may be located at the coupling of the fluid line and the main piston 86. The check valve 100 may include a spring 102 that biases the valve to close the fluid path between the main piston 86 and fluid line 93. In addition, the check valve 100 may be arranged such that gravity also assists in closing the fluid path between the main piston 86 and fluid line 93.

The check valve 100 may serve as a one-way-flow system. The check valve spring 102 may be arranged so as to open the fluid path between the main piston 86 and fluid line 93 when sufficient pressure builds up in the piston cylinder 98 so that the pressure may be communicated to the pressure chamber 76. Such an arrangement allows air to flow from the piston cylinder 98 to the fluid line 93 and on to the pressure chamber 76, without allowing air to flow from the fluid line 93 back into the piston cylinder 98. As the paddle compression mechanism 80 only pressurizes the piston chamber 98 when a wave impacts the paddles 82, 84, it will be readily understood that such a one-way-flow system may facilitate pressurization of the pressure chambers 76 by the paddle compression mechanisms 80.

Referring to FIGS. 14, 16, and 20, a number of components or devices may be positioned on the top surfaces 24 of the buoy 20. For example, a manhole 120 may be located in the top surface 24, so as to provide access to the hull 22 of the buoy 20. The manhole 120 may be utilized by workers during the installation of a buoy 20 to prepare the buoy 20 for operation. The manhole 120 may also be utilized by workers for general maintenance, troubleshooting, or repairing of the buoy 20 during operation of the buoy 20. The manhole 120 may be equipped with a cover (not shown) to prevent water or other substances from unintentionally entering the hull 22 of the buoy 20. There may be any appropriate number of manholes 120 located in the buoy 20, but there are preferably two manholes.

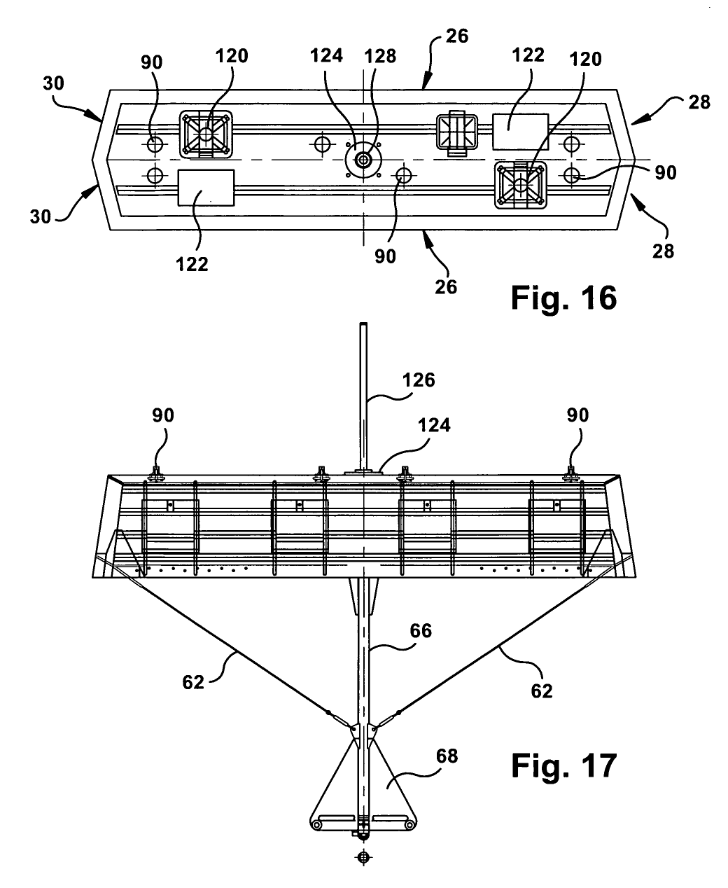

With reference to FIGS. 16 and 20, solar panels 122 may also be positioned on the top surfaces 24 of the buoy 20. The solar panels 122 may generate electricity to be either delivered to shore or for use locally on the buoy 20 to power systems on the buoy 20. Supercapacitors or ultracapacitors (not shown) may also be included for storage of the energy generated by the solar panels 122.

The energy generated by the solar panels 122 may be utilized locally to operate systems on the buoy 20. For example, the energy may be used to operate logic circuits that control the positioning of the buoy 20 and the paddle compression system 80. The energy also may be used to power solenoid valves used to operate the pneumatic systems previously described. The energy may also be used to run other systems such as, for example, warning lights that alert ships of the buoy's 20 position, antennas that send signals to alert ships of the buoy's 20 position, global positioning equipment, receivers to receive instructions from shore or international alerts, transmitters to send information to shore, and the like. The solar panels 122 may also be charged by a rechargeable battery.

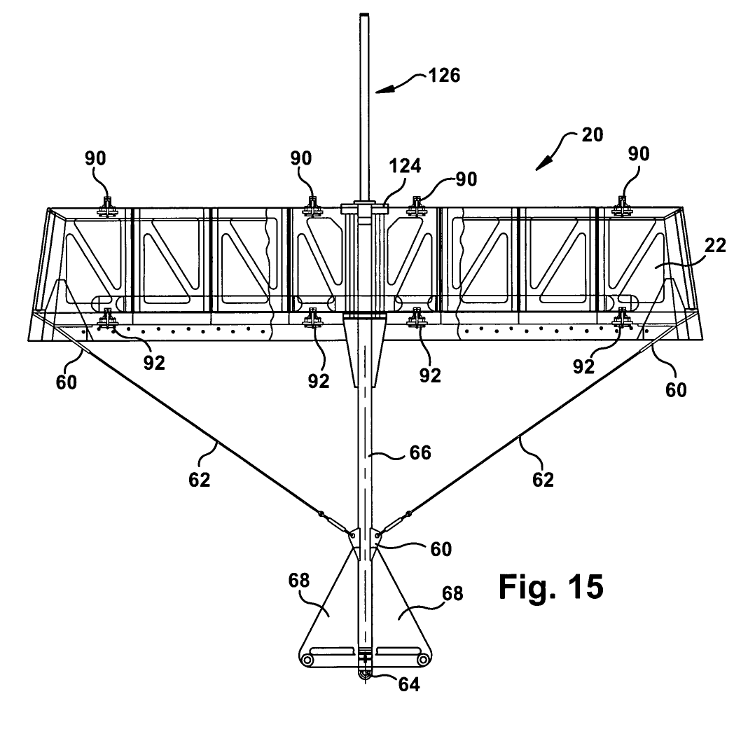

As an alternative embodiment, a platform 124 may be positioned and secured on the top surfaces 24 of the buoy 20. The platform 124 may be of any appropriate shape or size and should not be limited to that illustrated in FIGS. 15 and 16. A number of components, devices, and systems may be mounted onto the platform 124. Preferably, a tube 126 may be mounted within the platform 124 that may provide a container for housing various items, as shown in FIGS. 15-17. For example, an antennae array 128, which may include beacons, lights, communication antennas, cell phone antennas, radio antennas, signal relay antennas, global positioning equipment, and the like may be positioned within the tube 126.

Such communication antennas 128 may extend the reach of communication methods hundreds or thousands of miles across the ocean. The tube 126 may be maintained above the water surface so that air may be removed through the tube 126 for use with the buoy 20. The tube 126 also maintains and keeps the antennae array 128 located above the water surface so that the valves 90, 92 may be operated remotely via the antennae 128.

Other embodiments of wave energy recovery systems 10 are described in U.S. patent application Ser. No. 11/602,145 to Greenspan, et al., filed Nov. 20, 2006, and entitled “Wave Energy Recovery System,” which is hereby incorporated in its entirety.

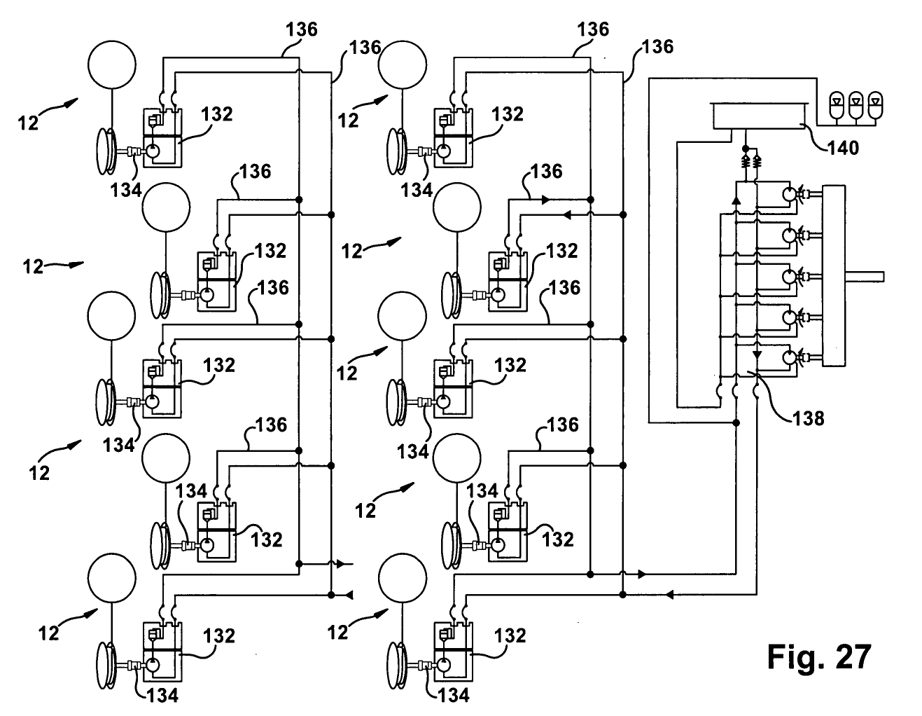

With reference to FIGS. 27-29, another embodiment of the present invention is illustrated. As an alterative, the energy of a wave may be harnessed to drive a pump to move hydraulic fluid to drive a generator. The motion translating assemblies 12 may be arranged such that each assembly 12 drives individual pumps 132 secured to each support platform 40. The assemblies 12 may be arranged to rotate a driveshaft 134 coupled to each pump 132.

Pressure lines 136 may couple each pump 132 to a multiple hydraulic pump drive system 138, for example, which may be located on shore. Each pressure line 136 may transmit pressure generated by each pump 132 to a central pressure repository or accumulator 140. This pressure repository 140 may release pressure, such as at a constant rate, to drive a flywheel of the multiple hydraulic pump drive system 138 to generate electric power. Such an arrangement may result in self-sufficient assemblies 12 and pumps 132.

It will be readily understood how the inclusion of flexible pressure lines 136 may allow for easy installation, as described above. Similar to the previous description, the multiple hydraulic pump drive system 120 may generate an AC current, which is converted to DC current by a rectifier. A voltage converter generates a consistent DC current to be used as a final source of electricity or to be converted back to AC current.

The embodiments, as described herein, allow for easy and inexpensive relocation of a wave energy recovery system. As will be readily understood, a system may be relatively easily and quickly disassembled and moved to a more desirable location. The modular nature of the embodiments allows for rapid expansion of an existing and operative system. In addition, the location of systems on a seabed provides for a self-cooling system, which improves operation and lowers maintenance costs as well.

The embodiments of the invention have been described above and, obviously, modifications and alternations will occur to others upon reading and understanding this specification. The claims as follows are intended to include all modifications and alterations insofar as they come within the scope of the claims or the equivalent thereof.

Having thus described the invention, we claim:

1. A wave energy recovery system comprising:
a motion translating assembly comprising:
a main buoy; and
a shaft coupled to said main buoy, wherein vertical motion of said main buoy is translated into rotational motion of said shaft; and
an electric power generating device coupled to said shaft, wherein rotational motion of said shaft results in said electric power generating device generating electric power.

2. A wave energy recovery system comprising:
a motion translating assembly comprising:
a main buoy;
a retracting buoy; and
a main cable coupled on one end to the main buoy and coupled on the other end to the retracting buoy;
a shaft;
a drum coupled to the shaft, wherein the main cable is wrapped around the drum, such that rotation motion of said drum is capable of translating into rotational motion of said shaft; and
a generator could to said shaft such that rotational motion of said shaft is capable of translating into rotational motion of said generator.

3. A method for recovering energy from waves comprising:
positioning a plurality of motion translating assemblies in a body of water;
positioning a shaft in said body of water;
positioning an electric power generating device in said body of water or proximate to said body of water;
coupling each of said plurality of motion translating assemblies to said shaft;
coupling said shaft to said electric power generating device;
translating vertical motion of said motion translating assemblies to rotational motion of said shaft; and
engaging rotational motion of said shaft to said electric power generating device to generate electric power.
